(19) United States
(12) Patent Application Publication
(10) Pub. No.: US 2022/0245589 A1
(43) Pub. Date: Aug. 4, 2022

(54) CONTRACT MANAGEMENT SYSTEM

(71) Applicant: Seventh Sense Consulting, LLC, Woodbridge, VA (US)

(72) Inventors: Lisa Akers, Fort Washington, MD (US); Kito Bradford, Rockville, MD (US); Patrick Shields, Bowling Green, VA (US)

(73) Assignee: Seventh Sense Consulting, LLC, Woodbridge, VA (US)

(21) Appl. No.: 17/589,481

(22) Filed: Jan. 31, 2022

Related U.S. Application Data
(60) Provisional application No. 63/144,363, filed on Feb. 1, 2021.

(51) Int. Cl. G06Q 10/10; G06Q 10/06; G06Q 50/26; G06Q 30/00

(52) U.S. Cl. CPC G06Q 10/103; G06Q 30/018; G06Q 50/26; G06Q 10/063114

(57) ABSTRACT

A computer software program automates government roles in monitoring contractors. The program tracks contract deliverables, schedule, funding, invoicing, and performance to simplify performance management. The program maintains all information relating to the project with notifications, workflow, collaborative platform, educational videos, and templates. It simplifies how one manages contracts from post-award to closeout. The program allows agencies to manage contracts intelligently in an organized and simplified method. The program is a comprehensive contractor management solution that includes productivity tools, process automation, tutorials and templates. It provides leadership with instant access into their portfolio of projects/contracts with the ability to drill down into individual projects/contracts. It provides an early warning system into projects/contracts at risk of delayed schedule, cost overruns, unsatisfactory quality and poor contract performance. It is designed to enhance the government employee's execution of contractor performance management best practices so there is a greater likelihood of project success.

### RELATED APPLICATIONS

The present application claims the benefit of U.S. Provisional Patent Application No. 63/144,363 filed by the same inventors on Feb. 1, 2021 with the same title and said Provisional Patent Application is hereby incorporated by reference as if repeated herein in its entirety including the original drawings.

### BACKGROUND

The present invention relates generally to methods and apparatuses for automating business processes, and more particularly to a method and apparatus for automating a business process, such as management of a United States Federal Government procurement contract.

In today's world the United States government relies heavily on contracts and is by far one of the single largest sources of the procurement of products and services in the United States. In 2018, the federal government spent $559 billion on contracts for products and services which represents the most the government has spent in contracts since fiscal 2010, according to an analysis from Bloomberg Government.

Despite the efforts of Congress and the executive branch to reduce costs and improve the quality of federal acquisitions, many problems still remain. According to the Federal Times, a report by the Government Accountability Office (GAO) GAO-18-627 Report on Federal Acquisitions dated Sep. 12, 2018, states that there are three main areas of improvement that can be made in the federal acquisitions sector: (1) requirements definition, (2) competition and pricing, and (3) contractor oversight.

While the current technology landscape is riddled with solutions that focus on the competition and pricing portion via more traditional contract life cycle management (CLM) software solutions, such as Unison Prism, CACI Comprizon Suite, and Oracle's CLM for the Public Sector, there is little to no competition in the government sector for either the requirements definition or contractor oversight areas of improvement noted by GAO.

The present invention is therefore directed to the problem of developing an automated system for managing government contracts that improves the contractor oversight segment of the government procurement cycle.

### SUMMARY OF THE INVENTION

The present invention solves these and other problems by providing a computer software program, Contractor Performance Intelligence® (CPI), that provides process automation for 90% of the Contracting Officer Representative's (COR's) and Project Manager's (PM's) role in monitoring contractor performance from award to contract closeout. Contractor Performance Intelligence tracks contract deliverables, schedule, funding, invoicing, and performance to simplify post-award performance management. The program maintains everything relating to the project in one place with notifications, workflow, collaborative platform, educational videos, and templates. The present invention simplifies how one manages contracts from post-award to closeout.

The present invention, termed herein Contractor Performance Intelligence, is strategically aligned and fits into the existing government landscape of contracting software solution providers. The present invention provides a contract management (funds tracking, deliverables tracking and contract modification requests) and/or performance management (contractor oversight) solution.

Contractor Performance Intelligence (CPI) allows agencies to manage contracts intelligently in an organized and simplified method. CPI is a comprehensive contractor management solution that includes productivity tools, process automation, tutorials and templates. CPI provides agency leadership with instant access into their portfolio of projects/contracts with the ability to drill down into individual projects/contracts.

CPI provides an early warning system into projects/contracts at risk of delayed schedule, cost overruns, unsatisfactory quality and poor contract performance. COR have lots of duties but few tools to assist in contractor performance management. CPI is designed to enhance the government Contracting Officer's Representative (COR) execution of contractor performance management best practices so there is a greater likelihood of project success. CPI provides one place for all COR related activities, files, tutorials and templates making it conveniently for CORs to perform their responsibilities in a timely, high-quality manner.

The present invention provides several features that differentiate it from other solutions. For example, CORs typically use shared drives and desktop office automation such as spreadsheets, documents, email and project management applications to manage their projects/contracts after award. Consequently, even within the same agency or even group with an agency, there is no consolidation or portfolio of the organization's projects/contracts. The present invention provides group or agency leadership with instant access into their portfolio of projects/contracts with the ability to drill down into individual projects/contracts. Additionally, the present invention provides an early warning system into projects/contracts at risk of delayed schedule, cost overruns, unsatisfactory quality and poor contract performance.

COR have lots of duties but few tools to assist in contractor performance management. The present invention supports 17 activities that the government Contracting Officer's Representative (COR) are directed to execute for contractor performance management building in COR best practices activities so there is a greater likelihood of project success. The present invention COR best practice activities include:

Performance Oversight and Management

1. Plan and document Post-Award Orientation (Kick-off meeting)

2. Create and execute Contract Management Plan (CMP)

3. Create and execute Quality Assurance Surveillance Plan (QASP)

4. Retain all records related to Deliverables and Performance Incentives

5. Provide Technical Direction and advice on technical matters

6. Communicate with CO regarding performance/schedule issues

7. Manage the schedule for deliverables and coordinate Government review of deliverables

8. Request for contract modification

9. Prepare CPARs input

10. Inspect and accept materials submitted by contractor

Financial and Administrative Oversight Functions

1. Account for Government Furnished Property (GFP) and Government Furnished Information (GFI)

2. Manage financial status of the contract

3. Track invoices/vouchers

4. Retain all records related to Request to Travel, Request to Purchase Other Direct Costs

5. Coordinate security background checks and site entry matters for contractor personnel

Closeout Process Assistance

1. Prepare for contract closeout

2. Prepare for final contract modification to closeout contract

The present invention includes intelligent process automation for the activity of requesting a contract modification. Based on the user's selection of the contract modification type, the system guides the user through the Modification Consideration Decision Process that is expanded in FIG. 20 later in this document. Depending on the modification type selected by the user, the system asks the user additional questions that shape the steps necessary to complete the modification.

The present invention provides has embedded content in the form of video tutorials and templates that is linked to related activities so that the user can improve their knowledge while executing the action. The content is also available through the top navigation bar via the tutorials and templates tabs and can be filtered by selecting which work category the user is interested in (e.g. contract management and oversight, contract administration, modifications, contract closeout).

The present invention replaces agencies' shared drive for COR contract files with the CPI system and its organized repository. Agency shared drives tend to be difficult to search, inconsistent organizational structure, and difficult to audit that the required files are stored. CPI allows different user roles to search and filter to access files through multiple ways such as the project list, the activity list, the invoice list, the contractor list, repository and reports with links to the desired information. Having everything in CPI makes it easier to transition to new CORs and streamline contract closeout.

The present invention provide an ‘Ask the Experts’ feature for support to allow users to ask acquisition-related questions.

According to one aspect of the present invention, an exemplary embodiment of an apparatus for managing a contract, including a U.S. government contract, includes an on-premises network coupled via an external network, such as the Internet, to an off-premises network. The on-premises network is designed to be coupled to the external network. The on-premises network employs a collaborative server with a front end application server, an email server and a database server. The front-end server is designed to be coupled to the email server and the database server. The off-premises network also employs a collaborative server with a web server, an email server and a database server. The web server in this collaborative server is also coupled to the email server, and the database server within the collaborative server.

The front end application server uses non-transitive computer readable media with instructions encoded thereon causing the front end application server to provide a contractor performance intelligence application. The contractor performance intelligence application employs a graphical user interface through which a user, such as a contracting officer's representative, can manage aspects of a government contract throughout a life cycle of a government contract, including post-award activities, scheduling, costs, and contractor performance.

The contractor performance intelligence application may include functionality that enables users to manage multiple government contracts simultaneously, wherein the users include contracting officers, contracting officer's representatives, supervisory personnel of said contracting officers and said contracting officer's representatives, security officers, technical representatives, and accountants. The contractor performance intelligence application may also include functionality that enables supervisory personnel to review performance criteria of those government contracts being managed by others.

The contractor performance intelligence application may include an early warning system identifying projects at risk of delayed schedules, cost overruns, unsatisfactory quality and poor contractor performance.

The contractor performance intelligence application may include an automation process for requesting a contract modification that guides a user through a modification consideration decision process that prompts the user with questions to shape those steps necessary to develop a contract modification request in accordance with U.S. government federal acquisition regulations.

The contractor performance intelligence application may include video tutorials and templates that are linked to specific activities, whereby a user can select any of the video tutorials and templates to help guide the user when performing these specific activities.

The contractor performance intelligence application may include functionality that provides different user roles and allows each different user role to search, filter and access files through multiple ways, including by lists of projects, activities, invoices, contractors, repositories and reports.

The contractor performance intelligence application may include an ask the experts capability to enable users to ask acquisition-related questions to which the contractor performance intelligence application provides ad-hoc responses to new questions that have not been posed by any user or answered previously, as well as pre-programmed responses to questions previously posed or answered.

In this apparatus, the aspects of a government contract may include performance oversight and management activities, financial and administrative oversight functions, and closeout process assistance functions—all to be performed by a contracting officer's representative.

In this apparatus, those performance oversight and management activities may include one or more of the following:

(i) planning and documenting post-award orientation, including a kick-off meeting;

(ii) creating and executing a contract management plan;

(iii) creating and executing a quality assurance surveillance plan;

(iv) retaining and storing all records related to deliverables and performance incentives in said first and second databases;

(v) providing technical direction and advice on technical matters;

(vi) communicating with a contracting officer regarding performance and schedule issues via the first and second email servers;

(vii) managing a schedule for deliverables and coordinate government review of deliverables;

(viii) submitting one or more requests for contract modification;

(ix) preparing input to one or more contractor performance assessment reports; and

(x) inspecting and accepting materials submitted by one or more contractors.

In this apparatus, those financial and administrative oversight functions may include one or more of the following:

(i) accounting for government furnished property and government furnished information;

(ii) managing a financial status of said government contract;

(iii) tracking one or more invoices and payment vouchers;

(iv) storing and retaining all records related to one or more requests to travel, and one or more requests to purchase other direct costs; and

(v) coordinating one or more security background checks and one or more site entry matters for contractor personnel.

In this apparatus, those closeout process assistance functions may include one or more of the following:

(i) preparing for closeout of said government contract; and

(ii) preparing for final contract modification to closeout said government contract.

In this apparatus, the contractor performance intelligence application may employ a hierarchical data structure starting with projects, such as contracts, each of which employs activities, which in turn employs action items for each activity, and notifications related to one activity or one action item.

According to another aspect of the present invention, a non-transitive computer readable media has encoded thereon instructions that cause a processor, such as a server, to provide a contractor performance intelligence application. The contractor performance intelligence application employs a graphical user interface through which a user, such as a contracting officer's representative, can manage various aspects of a government contract throughout a life cycle of a government contract, including post-award activities, scheduling, costs, and contractor performance. The contractor performance intelligence application includes a variety of functionality, such as:

a) enabling users to manage multiple government contracts simultaneously, wherein the users include contracting officers, contracting officer's representatives, supervisory personnel of said contracting officers and said contracting officer's representatives, security officers, technical representatives, and accountants;

b) enabling supervisory personnel to review performance criteria of government contracts being managed by others;

c) identifying via an early warning system those projects at risk of delayed schedules, cost overruns, unsatisfactory quality and poor contractor performance;

d) including an automation process for requesting a contract modification that guides a user through a modification consideration decision process that prompts the user with questions to shape those steps necessary to develop the contract modification request in accordance with U.S. government federal acquisition regulations;

e) including video tutorials and templates that are linked to specific activities, whereby a user can select any of the video tutorials and templates to help guide the user when performing a specific activity;

f) providing different user roles and allowing of the different user roles to search, filter and access files through multiple ways, including by lists of projects, activities, invoices, contractors, repositories and reports; and

g) providing an ask the experts capability to enable users to ask acquisition-related questions to which the contractor performance intelligence application provides ad-hoc responses to new questions that have not been posed by any user or answered previously, as well as pre-programmed responses to questions previously posed or answered.

In this non-transitive computer readable media, the aspects of a government contract may include performance oversight and management activities, financial and administrative oversight functions, and closeout process assistance functions—all to be performed by a contracting officer's representative.

In this non-transitive computer readable media, the performance oversight and management activities may include one or more of the following:

a) planning and documenting post-award orientation, including a kick-off meeting;

b) creating and executing a contract management plan;

c) creating and executing a quality assurance surveillance plan;

d) retaining and storing all records related to deliverables and performance incentives in said first and second databases;

e) providing technical direction and advice on technical matters;

f) communicating with a contracting officer regarding performance and schedule issues via the first and second email servers;

g) managing a schedule for deliverables and coordinate government review of deliverables;

h) submitting one or more requests for contract modification;

i) preparing input to one or more contractor performance assessment reports; and

j) inspecting and accepting materials submitted by one or more contractors.

In this non-transitive computer readable media, the financial and administrative oversight functions may include one or more of the following:

a) accounting for government furnished property and government furnished information;

b) managing a financial status of said government contract;

c) tracking one or more invoices and payment vouchers;

d) storing and retaining all records related to one or more requests to travel, and one or more requests to purchase other direct costs; and

e) coordinating one or more security background checks and one or more site entry matters for contractor personnel.

In this non-transitive computer readable media, the closeout process assistance functions may include one or more of the following:

a) preparing for closeout of said government contract; and

b) preparing for final contract modification to closeout said government contract.

In this non-transitive computer readable media, the contractor performance intelligence application may employ a hierarchical data structure starting with projects, such as contracts, each of which employs multiple activities, which in turn employs action items for each activity, and notifications related to one activity or one action item.

According to yet another aspect of the present invention, an exemplary embodiment of a method for managing a government contract using an intelligent process embedded in a contractor intelligence performance application for execution on a server includes several steps, such as:

providing a graphical user interface through which a user, such as a contracting officer's representative, can manage various aspects of a government contract throughout a life cycle of a government contract, including post-award activities, scheduling, costs, and contract performance;

providing access to the contractor performance intelligence application by predetermined user roles for users to manage multiple government contracts, wherein the users include: contracting officers, contracting officer's representatives, supervisory personnel of said contracting officers and said contracting officer's representatives, security officers, technical representatives, and accountants;

providing access to the contractor performance intelligence application to supervisory personnel to enable them to review performance criteria of several government contracts being managed by others;

identifying automatically by an early warning system those projects at risk of delayed schedules, cost overruns, unsatisfactory quality and poor contractor performance;

automating a process for requesting a contract modification that guides a user through a modification consideration decision process that prompts the user with questions to shape steps necessary to complete the contract modification;

providing video tutorials and templates that are linked to specific activities, whereby a user can select any of the video tutorials and templates to help guide the user when performing any of these specific activities;

providing different user roles and allowing each different user roles to search, filter and access files through multiple ways, including by lists of projects, activities, invoices, contractors, repositories and reports; and

providing an ask the experts capability to enable users to ask acquisition-related questions to which the contractor performance intelligence application provides ad-hoc responses to new questions that have not been posed by any user or answered previously, as well as pre-programmed responses to questions previously posed or answered.

In this exemplary embodiment of the method for managing a government contract, the aspects of a government contract may include performance oversight and management activities, financial and administrative oversight functions, and closeout process assistance functions—all to be performed by a contracting officer's representative.

In this exemplary embodiment of the method for managing a government contract, the performance oversight and management activities may include one or more of the following:

a) planning and documenting post-award orientation, including a kick-off meeting;

b) creating and executing a contract management plan;

c) creating and executing a quality assurance surveillance plan;

d) retaining and storing all records related to deliverables and performance incentives in said first and second databases;

e) providing technical direction and advice on technical matters;

f) communicating with a contracting officer regarding performance and schedule issues via the first and second email servers;

g) managing a schedule for deliverables and coordinate government review of deliverables;

h) submitting one or more requests for contract modification;

i) preparing input to one or more contractor performance assessment reports; and

j) inspecting and accepting materials submitted by one or more contractors.

In this exemplary embodiment of the method for managing a government contract, the financial and administrative oversight functions may include one or more of the following:

a) accounting for government furnished property and government furnished information;

b) managing a financial status of said government contract;

c) tracking one or more invoices and payment vouchers;

d) storing and retaining all records related to one or more requests to travel, and one or more requests to purchase other direct costs; and

e) coordinating one or more security background checks and one or more site entry matters for contractor personnel.

In this exemplary embodiment of the method for managing a government contract, the closeout process assistance functions may include one or more of the following:

a) preparing for closeout of said government contract; and

b) preparing for final contract modification to closeout said government contract.

In this exemplary embodiment of the method for managing a government contract, the contractor performance intelligence application may employ a hierarchical data structure starting with projects, such as contracts, each of which employs multiple activities, which in turn employs action items for each activity, and notifications related to one activity or one action item.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts a hardware architecture of an exemplary embodiment of a system for managing contracts, such as government contracts according to one aspect of the present invention.

FIG. 2 depicts a relationship of entities for the software of an exemplary embodiment of according to another aspect of the present invention.

FIGS. 3A-D, 4, 5A-E, 6, 7A-K, 7L1, 7L2, 7M-V, 8, 9A-B, 10-12, 13A-B and 14-15 depict various screen shots of a system for managing contracts, such as government contracts according to yet another aspect of the present invention.

FIGS. 16-18 depict the process and roles in our acquisition life cycle from acquisition planning, procurement (solicitation preparation, evaluation, source selection and award preparation), and contract management (contract performance, oversight and management).

FIG. 19 reflects the phase of the acquisition life cycle supported by the present invention.

FIG. 20 depicts the automated contract modification consideration decision process in the present invention.

### DETAILED DESCRIPTION

The present invention is designed to provide government acquisition professionals an easy, intuitive, and effective state-of-the art means by which to manage government contracts post-award through closeout. In addition, the present invention allows junior government acquisition professionals an opportunity to benefit from the knowledge and experience of more senior and tenured government acquisition professionals via in app workflows, templates, video tutorials, best practices, ask an expert, and a robust post-award through closeout knowledge base. Moreover, the present invention reduces the number of failed government contracts, the number of excess monies spent on both completed and failed contracts, and identifies and increases overall efficiencies that pertain to the purchase of goods and/or services for the United States government.

In agile software development, software is designed based on user stories that communicate the role, the need and the context for the need. The user stories are then used as the basis for design, development and test. The following user stories and/or use cases are employed to create the screen shots and processes of the present invention.

| Work Category | Title | User Story |
|---|---|---|
| Navigation | Add work | As a COR, when I login to the system, I want to be |
| | categories menu | able to see the following list of work category |
| | | items visible from all pages within the app: |
| | | 1. Contract Administration |
| | | 2. Contract Management/Oversight |
| | | 3. Modifications |
| | | 4. Closeout |
| | | so that I can easily access all deliverables and/ |
| | | or functionality related to each work category. |
| Navigation | Add left pane | As a COR, when I login to the system, I want to be |
| | menu | able to see the following list of top-level menu |
| | | items visible from all pages within the app: |
| | | 1. Projects |
| | | 2. Activities |
| | | 3. Invoices |
| | | 4. Contractors |
| | | 5. Repository |
| | | 6. Reports |
| | | 7. Support |
| | | so that I can easily access all work and/or |
| | | functionality related to each menu item. |
| Contract | Display contract | As a COR, when I login to the system and click on |
| Administration | administration page | the Contract Administration work category I am |
| | | taken to the contract administration home page |
| | | which includes the following items: |
| | | 1. Contract Management Plan (CMP) |
| | | Contract Administration Plan (CAP) |
| | | 2 Government Furnished Property (GFP) |
| | | 3. Government Furnished Information (GFI) |
| | | 4. Consent to Travel (CTT) |
| | | 5. Consent to Purchase (CTP) |
| | | so that I can easily access all work and/or |
| | | functionality related to those deliverables. |
| Contract | Display | As a COR, when I login to the system and click on |
| Management | and contract | the Contract Management and Oversight work |
| Oversight | management | category I am taken to the contract management |
| | and oversight page | and oversight home page which includes the |
| | | following items: |
| | | 1. Plan/Monitor Post-Award Orientation |
| | | 2. Quality Assurance Surveillance Plan |
| | | (QASP) |
| | | 3. Inspection Checklist |
| | | 4. Performance Incentive |
| | | 5. Support for Contractor Performance |
| | | Assessment Rating System (CPARS) |
| | | so that I can easily access all work and/or |
| | | functionality related to the contractor's |
| | | performance and deliverables. |
| Modifications | Display | As COR, when I login to the system and click on |
| | modifications page | the Modifications work category, I am taken to the |
| | | contract modifications page which includes the |
| | | following items: |
| | | 1. Definition of contract and modifications |
| | | 2. Ability to create modification |
| | | 3. Access modification templates |
| | | 4. View modification video tutorials |
| | | 5. Access a list of modification knowledge |
| | | base items |
| | | so that I can easily access modification |
| | | information and manage all of my work related to |
| | | this work category from one location. |
| Closeout | Display closeout page | As COR, when I login to the system and click the |
| | | Closeout work category, I am able to perform the |
| | | following: |
| | | 1 Search on all existing closeout work in the |
| | | system by date and/or status |
| | | 2. Create, view, edit, and delete closeout |
| | | deliverables |
| | | 3. Answer closeout checklist questions to guide |
| | | me through the contract closeout process |
| | | 4. Access closeout templates |
| | | 5. Watch closeout video tutorial's |
| | | 6. Access a list of closeout knowledge base |
| | | items |
| | | so that I can easily access closeout information and |
| | | perform all of my closeout deliverables from one |
| | | location. |
| Site | Display site | As a product manager, I want users to be able to |
| Feedback/Voice | feedback page | click a button that allows them to enter feedback |
| of Customer | | and/or suggestions so that they can help us to |
| | | resolve bugs, make our application easier, and |
| | | identify critical user needs that are not currently |
| | | being met. |
| | Search | As an acquisition analyst, I want to be able to enter |
| | documents in | text at the top of the repository for all matching |
| | repository | and/or similar lines of text and provide me a list |
| | | with links to relevant data items so that I can easily |
| | | locate and access any related information. |
| Support | Display | As an acquisition analyst, I want to be able to |
| | Support page | submit a support request so that if the application |
| | | is not performing properly and/or I need assistance |
| | | performing some activity I can submit a request |
| | | for assistance. I want to be able to call the support |
| | | line or request a support ticket. I want access to |
| | | other User Assistance articles so that I can help |
| | | myself if an article addresses my issue. |
| Support | Display | As a system user, I want to ask an acquisition |
| | Support page | expert for help on any acquisition-related topic |
| | and select Ask | with the ability to provide my contact info, the |
| | the Experts | question, upload files for consideration by the |
| | | expert. |
| Settings | Display | As a COR, I want to be able to access a settings |
| | settings/ | page that allows me to view my user name, update |
| | Configuration | my password, edit my contact information, edit |
| | page | my department, and/or configure other settings so |
| | | that I can view relevant information and make |
| | | adjustments that will allow me to have a better |
| | | user experience. |
| Authentication | User Authentication | As an acquisition analyst, I want to be able to enter |
| | | my username and password to login to my ES |
| | | Contractor Performance Intelligence module so |
| | | that I can perform my work duties related to the |
| | | management of post-award contracts for the |
| | | federal government. |
| Dashboard | Add dashboard views | As an acquisition professional (COR, CO, |
| | | Director, Head Contracting activity) when I login |
| | | to the system and/or click on the CPI logo, I am |
| | | taken to a dashboard page which includes the |
| | | below metrics and/or key performance indicators: |
| | | 1. Total funding dollars |
| | | 2. Workload tracking by users' direct reports |
| | | 3. Burn rate |
| | | 4. Department contracts |
| | | 5. Top contractors |
| | | 6. Projects |
| | | 7. Upcoming activities |
| | | 8. High priority action items |
| | | 9. Invoices by status |
| | | 10. Total Funding (expended vs obligated) |
| | | 11. Top contractors |
| | | 12. Department contracts |
| | | 13. Software license inventory contracts |
| | | 14. OMB category management |
| | | 15. Top categories of spend |
| | | so that I can know at a glance which issues need |
| | | my attention sooner as opposed to others. |
| Projects | Display projects page | As an acquisitions analyst (COR, CO, Director, |
| | | Head Contracting activity), when I login to the |
| | | system and click the projects menu item, I am |
| | | taken to the project home page which includes: |
| | | 1. a list of all existing projects, POC's, and |
| | | contractors for each project in the system |
| | | prioritized by date and priority level based on |
| | | filtering by My Projects, My Teams Projects, or |
| | | all Projects under my supervision |
| | | 2. options to create, view, edit, and delete |
| | | projects |
| | | so that I can easily access project information and |
| | | manage project activities based on my role. |
| Projects | Create a project | As a COR, after clicking the create project button |
| | | on the project home page, I want to enter the |
| | | Contract/BPA/Order PID and pull in the award |
| | | data from the government-wide FPDS-NG |
| | | database or my agency's contract writing system |
| | | thereby reducing need for data entry but allowing |
| | | me to confirm the validity of the information when |
| | | creating a project: |
| | | Project Title |
| | | Burn Rate Calculator |
| | | Contract Details |
| | | Contract # (includes Contract/BPA/Order PID) |
| | | Contract type (FPDS-NG) |
| | | NAICS code (FPDS-NG) |
| | | NAICS Description (FPDS-NG) |
| | | Department |
| | | Description |
| | | Contractor name (FPDS) |
| | | Identification of the Acquisition Team |
| | | Contracting Officer required (FPDS-NG) |
| | | Contracting Officer's Representative required |
| | | Program/Project Manager optional |
| | | Contract Specialist optional |
| | | Additional teammates |
| | | Financial/PoP Information |
| | | Award Date (FPDS-NG) |
| | | Ultimate Completion Date (FPDS-NG) |
| | | Value including all Options (FPDS-NG) |
| | | Current Option Period (FPDS-NG) |
| | | Start date for base period (FPDS-NG) |
| | | End date for base period (FPDS-NG) |
| | | Total obligation (FPDS-NG) |
| | | Total Value (FPDS-NG) |
| | | Future Option Periods (FPDS-NG) |
| | | Start dates for all option periods |
| | | End dates for all option periods |
| | | Total obligation |
| | | CLIN/Obligation amount |
| | | so that I can track and monitor all of the important |
| | | information related to the execution and |
| | | completion of my contract/project. |
| Activity | Display project | As an acquisitions analyst, when I login to the |
| | activities page | system and click the activities menu item, I am |
| | | taken to the activity home page which includes: |
| | | 1. a list of all existing activities in the system |
| | | sortable by/project |
| | | 2. options to create, view, edit, and delete |
| | | activities |
| | | 3. activity templates |
| | | 4. activity video tutorial's |
| | | 5. a list of activity knowledge base items |
| | | so that I can easily access activity information and |
| | | manage all of my activities from one location. |
| Activity | Create an activity | As a COR, after clicking the create activity button |
| | | on the activity home page, I am able to enter the |
| | | below information while creating an activity: |
| | | 1. title |
| | | 2. type |
| | | 3. description |
| | | 4. due date, actual receipt date |
| | | 5. status |
| | | 6. if due date or receipt date are filled in, |
| | | select if I want to setup a notification to the |
| | | project team members |
| | | 7. enter the assigned POC |
| | | 8. upload one or more documents |
| | | so that I can track and monitor all documentation |
| | | and deliverables related to the execution and |
| | | completion of my contract/project. This system |
| | | shall be the system of record to perform all COR |
| | | duties as delegated by the Contracting Officer and |
| | | shall be the official COR files over the life of each |
| | | contract/project. |
| Activity | Activity Types | As a COR, when creating an activity, I want to be |
| | | able to choose from the below types: |
| | | 1. Plan/Monitor Post-Award Orientation Notice |
| | | 2. Quality Assurance Surveillance Plan (QASP) |
| | | 3. Inspection Checklist |
| | | 4. Support for Contractor Performance |
| | | Assessment Rating System (CPARS) |
| | | 5. Contract Management Plan (CMP)/ |
| | | Contract Administration Plan (CAP) |
| | | 6. Government Furnished Property (GFP) |
| | | 7. Government Furnished Information (GFI) |
| | | 8. Consent to Travel (CTT) |
| | | 9. Consent to Purchase (CTP) |
| | | 10. Performance Incentive |
| | | 11. Contract Modification |
| | | 12. Contract Closeout |
| | | 13. Deliverable |
| | | 14. Other |
| | | so that I can track and monitor all activities and |
| | | deliverables by type throughout the completion of |
| | | my contract/project. |
| Contract | Plan/Monitor | As a COR creating activity related to post-award |
| Management/ | Post-Award | orientation, I want to be able to assign the task of |
| Oversight | Orientation | planning and monitoring the orientation, creating |
| | | and tracking notifications with email reminders, |
| | | allow attachment of the files related to the |
| | | orientation that the system can then share with all |
| | | assigned team members. |
| Contract | Quality | As a COR responsible for surveilling the quality |
| Management/ | Assurance | assurance performed by the contractor, I want the |
| Oversight | Surveillance | ability to: |
| | Plan (QASP) | 1. Keep formal record of the QASP's issue |
| | | date, status, and version of the QASP |
| | | 2. Store the QASP and all performance |
| | | surveillance files associated with the |
| | | contract in the system |
| | | 3. Provide tutorial on QASP |
| | | 4. Provide templates for QASPs |
| | | So that I surveil the contractor's quality assurance |
| | | process. |
| Contract | Inspection Checklist | As a COR responsible for performing inspection |
| Management/ | | on all deliverables under the contract/project, I |
| Oversight | | want the system to: |
| | | 1. Store the Inspection Checklist for the |
| | | contract deliverables |
| | | 2. Provide official records of all performance |
| | | inspections performed |
| | | 3. Provide templates for Inspection |
| | | Checklists. |
| Contract | Support for | As a COR responsible for managing and |
| Management/ | Contractor | overseeing the contractor's performance and |
| Oversight | Performance | leading the periodic assessment for submission to |
| | Assessment | the government wide CPARS, I want the ability to: |
| | Rating System | 1. Automatically pre-populate information |
| | (CPARS) | about the contract and contractor so that I |
| | | am not recreating the information |
| | | 2. Calculate the contract level of completion |
| | | 3. Record the level of complexity, |
| | | competition status, termination if |
| | | applicable |
| | | 4. Prepopulate the subcontractors under the |
| | | prime contractor |
| | | 5. Show the past ratings in the evaluation |
| | | areas of quality, schedule, cost control, |
| | | management and small business |
| | | subcontracting, regulatory compliance and |
| | | other areas that each contract defines |
| | | 6. Calculate the cost variance during the |
| | | current period and at completion |
| | | 7. Capture the schedule variance |
| | | 8. Capture recommendations of the assessing |
| | | officials |
| | | So that the government performs the contractor |
| | | performance assessment in accordance with the |
| | | federal acquisition regulations and agency |
| | | regulations to ensure there is official |
| | | communication to the contractor related to |
| | | contractor performance as well as to other |
| | | agencies considering awarding contracts to the |
| | | same contractor. |
| Contract | Create, edit, | As a COR responsible for surveilling the quality |
| Administration | update a | assurance performed by the contractor, I want the |
| | Contract | ability to: |
| | Management | 1. Keep formal record of the CMP/CAP's |
| | Plan (CMP)/ | issue date, status, and version of the plan |
| | Contract | 2. Store the CMP/CAP and all management |
| | Administration | activities associated with the contract in the |
| | Plan (CAP) | system |
| | | 3. Provide tutorial on Contractor Performance |
| | | Management and Contract Administration |
| | | 4. Provide template for CMP/CAP |
| | | So that I can properly fulfill my role in contract |
| | | management. |
| Contract | Government | As a COR responsible for providing and tracking |
| Administration | Furnished | government furnished property to the contractor, I |
| | Property | want: |
| | (GFP) | 1. Repository for records of government |
| | | furnished property |
| | | 2. To track the issue date and assignment of |
| | | the property |
| | | 3. Template for GFP/GFI |
| | | so that at contract completion, there is an accurate |
| | | record of all government furnished property for |
| | | property disposition and contract closeout. |
| Contract | Government | As a COR responsible for providing and tracking |
| Administration | Furnished | government furnished information to the |
| | Information | contractor, I want to track: |
| | (GFI) | 1. The records of GFI |
| | | 2. Track the issue date and assignment of the GFI |
| | | 3. Template for GFP/GFI |
| | | so that at contract completion there is an accurate |
| | | record of all government furnished information for |
| | | disposition and contract closeout. |
| Contract | Consent to | As a COR responsible for managing and |
| Administration | Purchase | overseeing the contractor's purchase of equipment, |
| | (CTP) | I want to: |
| | | 1. Track the description of purchase request, |
| | | from the contractor, date received, status |
| | | and CTP document |
| | | 2. Schedule notification for approval of the CTP |
| | | 3. Relate the CTP to invoice that bills the |
| | | government for the purchase |
| | | 4. Have access to CTP templates |
| | | 5. Have access to tutorials |
| | | so that I perform my fiduciary responsibilities. |
| Contract | Consent to | As a COR responsible for managing and |
| Administration | Travel (CTT) | overseeing the contractor's purchase of equipment, |
| | | I want to: |
| | | 1. Track the description of purchase request, |
| | | from the contractor, date received, status |
| | | and CTT document |
| | | 2. Schedule notification for approval of the |
| | | CTT |
| | | 3. Relate the CTT to invoice that bills the |
| | | government for the purchase |
| | | 4. Have access to CTT templates |
| | | 5. Have access to tutorials |
| | | so that I perform my fiduciary responsibilities. |
| Contract | Performance | As COR responsible for managing contractor |
| Management/ | Incentive | performance and recommending payment for |
| Oversight | | performance incentive, I want to: |
| | | 1. Track the description of performance |
| | | incentive consideration, assignment for |
| | | consideration, status, attach supporting |
| | | files |
| | | 2. Schedule notification for |
| | | recommendation of the performance |
| | | incentive |
| | | 3. Have access to Performance Incentive |
| | | plans and determinations templates |
| | | so that I ensure that contract performance |
| | | incentives are evaluated and awarded in a timely |
| | | manner. |
| Contract | Create, edit, | As a COR when I create, edit or update a contract |
| Performance | update a | modification request activity, I want to select the |
| Revisions | contract | modification type and then have the system guide |
| | modification | me through the specific steps, conditions and |
| | | information needed for each specific modification |
| | | type: |
| | | 1. Revise information (admin changes) |
| | | 2. Add/de-obligate funds |
| | | 3. Within general contract scope |
| | | 4. Additions to requirements |
| | | 5. Change COR |
| | | so that my modification request includes all the |
| | | required information for the Contracting Officer's |
| | | execution of the modification. I want the system |
| | | to intelligently automate the modification |
| | | consideration decision process based on what I |
| | | enter about the required modification so that the |
| | | modification process is streamlined reducing time |
| | | to perform and accurate to reduce rework (FIG. |
| | | 20). |
| Contract | Create, edit, | As a COR when I request closeout of a contract, I |
| Completion and | update | want: |
| Closeout | contract | 1. Guidance through the closeout process with |
| | closeout | all considerations/steps in logical order to |
| | | consider government property matters, |
| | | financial reconciliation, resolution to legal |
| | | 2. Prompt on the required documents to |
| | | include for contract closeout |
| | | 3. Ability to create scheduled notifications |
| | | 4 Attach all required files and package the |
| | | files for email submission to Contracting |
| | | Officer and contract writing system |
| | | 5. Templates for closeout related documents |
| | | and correspondence |
| | | So that the contract closeout package is accurate, |
| | | complete and streamlined for submission. |
| Contractors | Display | As an acquisition analyst, when I login to the |
| | contractors | system and click the contractors menu item, I am |
| | page | taken to the contractor home page which includes: |
| | | 1. a list of all existing contractors in the |
| | | system prioritized OMB category |
| | | management tier ranking |
| | | 2. options to create, view, edit, and delete |
| | | contractors |
| | | 3. the ability to upload/delete documents |
| | | from contractors' profiles |
| | | 4. a list of contractor knowledge base items |
| | | so that I can easily access contractor information |
| | | and manage all of my contractors in one location. |
| Invoices | Display | As a COR, when I login to the system and click |
| | invoices page | the invoices menu item, I am taken to the invoice |
| | | home page which includes: |
| | | 1. A list of all existing invoices in the system |
| | | prioritized by date, priority level, and |
| | | contractor |
| | | 2. Options to create, view, edit, and delete |
| | | invoices |
| | | 3. Invoice templates |
| | | 4. Invoice tutorials |
| | | 5. A list of invoice knowledge base items |
| | | so that I can easily access all of my invoices from |
| | | one location and manage the spend/burn rate on |
| | | my projects. |
| Tutorials | Display | For any user role in the system, I am taken to the |
| | tutorials page | tutorial home page which includes: |
| | | 1. A list of all tutorials in the system |
| | | 2. A search bar which allows me to search for |
| | | tutorials |
| | | 3. A list of tutorial knowledge base items |
| | | so that I can easily access tutorial information. I |
| | | also want access to relevant tutorials from the |
| | | activity pages in the system. |
| Templates | Display | As a COR, when I login to the system and click |
| | templates page | the templates menu item, I am taken to the |
| | | template home page which includes: |
| | | 4. A list of all existing templates in the |
| | | system prioritized by date and priority |
| | | level |
| | | 5. Options to create, view, edit, and delete |
| | | templates |
| | | 6. A search bar which allows me to search for |
| | | templates |
| | | 7. A list of template knowledge base items |
| | | so that I can easily access template information. |
| | | and manage all of my templates from one location. |
| | | I also want access to relevant templates from |
| | | activity pages in the system. |
| Repository | Display | As an acquisitions analyst, when I login to the |
| | repository | system and click the repository menu item, I am |
| | page | taken to the repository home page which includes: |
| | | 1. A list of all existing repositories items in |
| | | the system prioritized by contract requirements |
| | | and work products |
| | | 2. Options to upload/download, view, and |
| | | delete repository items as well as edit |
| | | repository item meta data |
| | | so that I can easily access all documentation stored |
| | | in the system for all of my contracts in one |
| | | location. |
| Repository | Repository | As a COR or acquisition analyst, when I upload |
| | upload | and/or attach a document to a project, activity, |
| | functionality | action item, invoice, contractor and/or any other |
| | | items, I want to open the Repository page and see |
| | | those documents reflected there so that all the |
| | | project documentation is stored in a central |
| | | location and provide proper COR and contract file |
| | | records management. |
| Permissions & | Create user | As a product manager, I want to ensure that |
| Roles | permissions | different users are able to access different |
| | and roles | functionality so that each user has access to the |
| | | functionality that they need to perform the duties |
| | | required by their respective position. |
| Reports | Display | As a COR, when I login to the system and click |
| | reports page | the reports menu item, I am taken to the reports |
| | | home page which displays the below reports: |
| | | 1. Total funding dollars report (expended, |
| | | obligated, and awarded) |
| | | 2. Track total expended against contract |
| | | balances report |
| | | 3. Invoice processing reports (total invoices |
| | | received, paid, pending against contract |
| | | CLIN's, etc.) |
| | | 4. Burn rate report |
| | | 5. Category Management Tier III, II, I |
| | | contractor report |
| | | 6. Contractor spend category report |
| | | 7. Agency Software License Inventory report |
| | | 8. Invoice audit report(s) |
| | | 9. Additional reports as necessary and requested |
| | | by users |
| | | so that I can view various Key Performance |
| | | Indicators, metrics, and review contract |
| | | performance. |
| Notifications | Add contract | As a COR, I want to receive an email notification |
| | period ending | and a system alert X days before a current contract |
| | (days) | period ends so that I can review the current |
| | notification | invoices, burn rate, and/or other statuses that will |
| | | identify what steps that I need to take before |
| | | closing out the contract. |
| Notifications | Add contract | As a COR, I want to receive an email notification |
| | period ending | and a system alert X months before a current |
| | (months) | contract period ends so that I can review the |
| | notification | current invoices, burn rate, and/or other statuses |
| | | that will identify what steps that I need to take |
| | | before closing out the contract. |
| Notifications | Add review | As a COR, I want to receive an email notification |
| | invoices | and a system alert X days after I have received an |
| | notification | invoice from a contractor so that my agency |
| | | doesn't have to pay interest to the contractor for |
| | | each day that I am late in reviewing their invoice. |
| Notifications | Add contractor | As a COR, I want to receive an email notification |
| | deliverable | and a system alert if a contractor fails to turn in |
| | notification | deliverables on time (e.g., due date of deliverables |
| | | versus actual receipt date) so that we can identify |
| | | problems and quickly bring them to both the |
| | | contractor and CO's attention for resolution. |
| Notifications | Add low | As a COR, I want to receive an email notification |
| | funding | and a system alert when funding is getting low so |
| | notification | that I can take the steps needed to ensure that the |
| | | government has adequate funds to complete the |
| | | project and the contractors are able to continue |
| | | work without potentially having to stop. |
| Integration | Integration | As a COR, I want to be able to view projects and |
| | with CLM | other relative information that I have entered in |
| | | our contract lifecycle management (CLM) |
| | | software in my CPI performance management so |
| | | that I don't have to manually setup new projects |
| | | and deliverables. |
| Integration | Integration | As a COR, I want to be able to view projects and |
| | between | other information relevant to the management of |
| | Enlightened | my contracts post-award that I entered in the ES |
| | Solutions | acquisition planning module in the ES contractor |
| | Acquisition | performance module so that I don't have to enter |
| | Planning and | information more than once throughout the |
| | Contractor | contract life cycle. |
| | Performance | |
| | Intelligence | |
| | modules | |

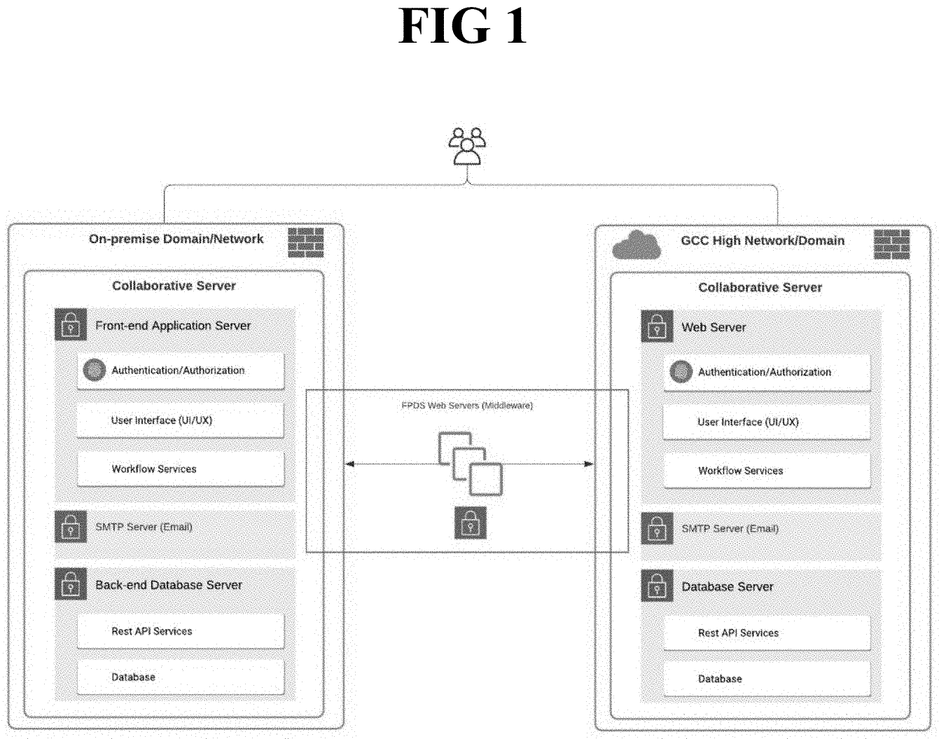

Turning to FIG. 1, this diagram depicts the technical architecture for the On-premises Domain/Network should the client want the system deployed on their computer server versus if they want it deployed on a cloud server, e.g., a GCC High Network/Domain. All software and hardware integrate to execute a predefined series of workflows that allow users to manage acquisitions and/or contracts. The process starts when a user attempts to login to the system. First and foremost, software which resides on the front-end application server is used to both authenticate and authorize the user. Once the user has gained access to the system all their existing work is loaded into view using data stored in various database tables. Throughout the course of their interaction with the system, software located in distinct locations and/or on specific servers/hardware is used to coordinate various tasks. These tasks include but are not limited to the following:

1. the display and analysis of reporting and/or statistical information

2. the execution of custom workflows (Front-end application server, Back-end Database Server)

3. scheduling and sending out notifications (Front-end application server, Back-end Database Server, SMTP server)

4. the consolidation, retention, and display of various documents in electronic format (Front-end application server, Back-end Database Server)

5. performing encrypted real-time push and pull data operations from various ancillary systems (e.g., financial and/or accounting systems, external databases, FPDS, etc.) (Front-end application server, Back-end Database Server).

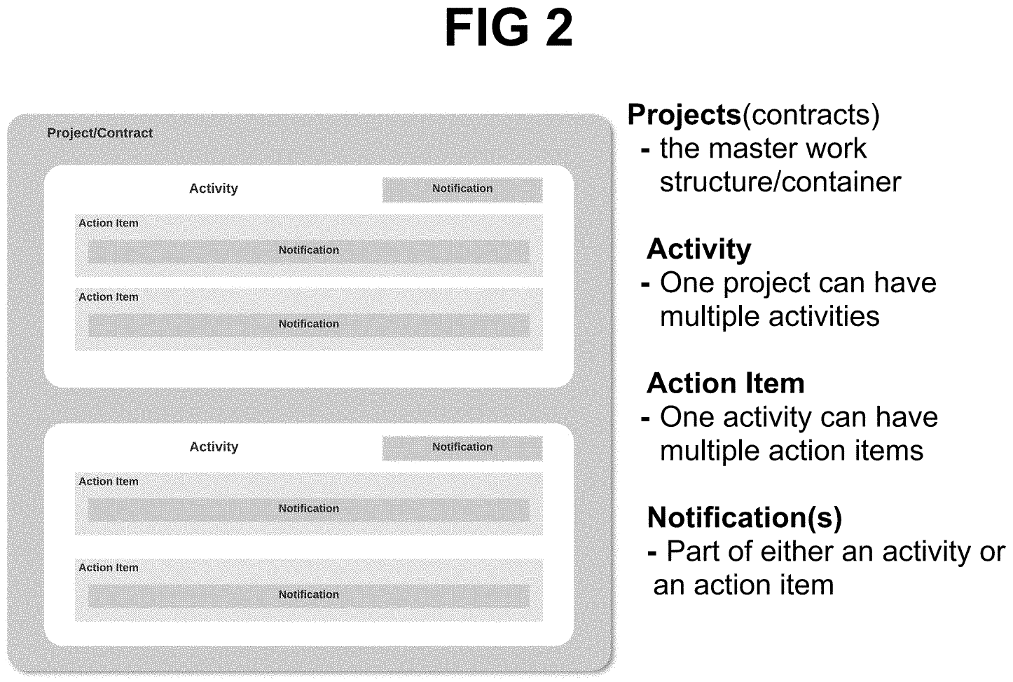

FIG. 2 shows the data architecture for the system that is hierarchical structure starting with the Projects (contracts) which can have multiple Activities related to the Project, which in turn can have multiple Action Items associated to an Activity, and Notifications that can be related to Activity and Action Items.

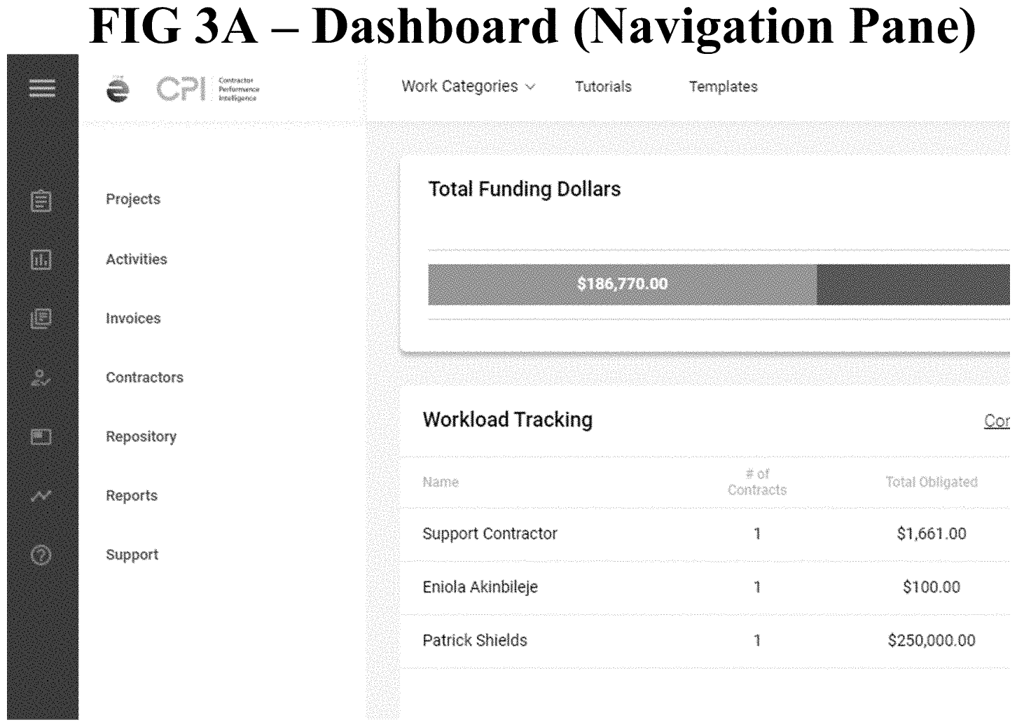

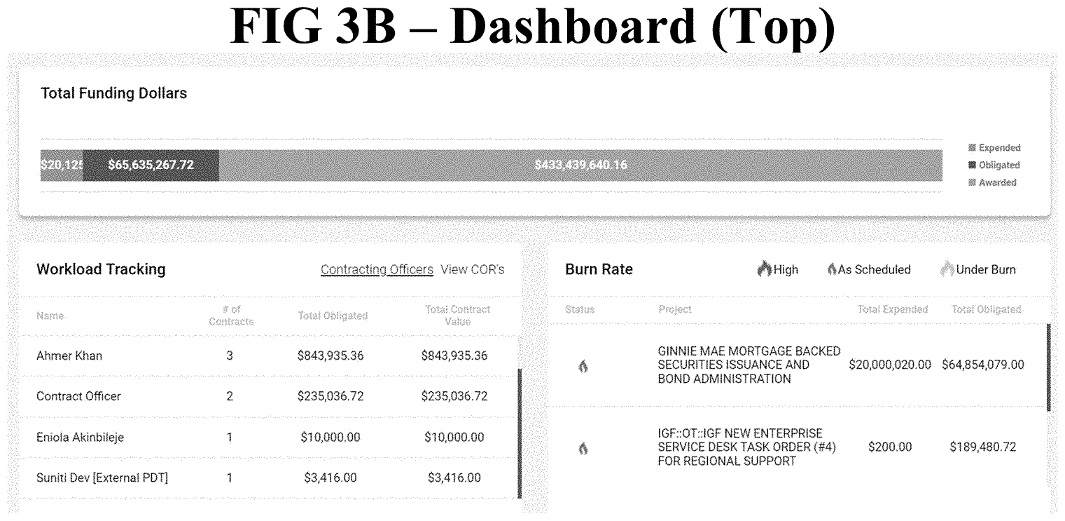

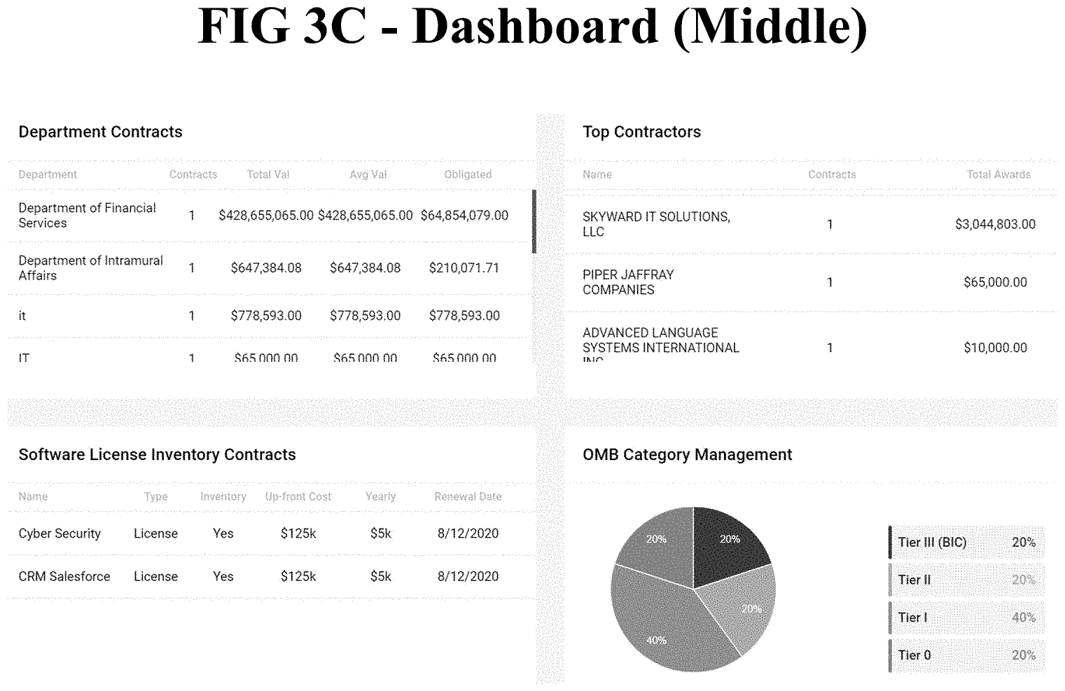

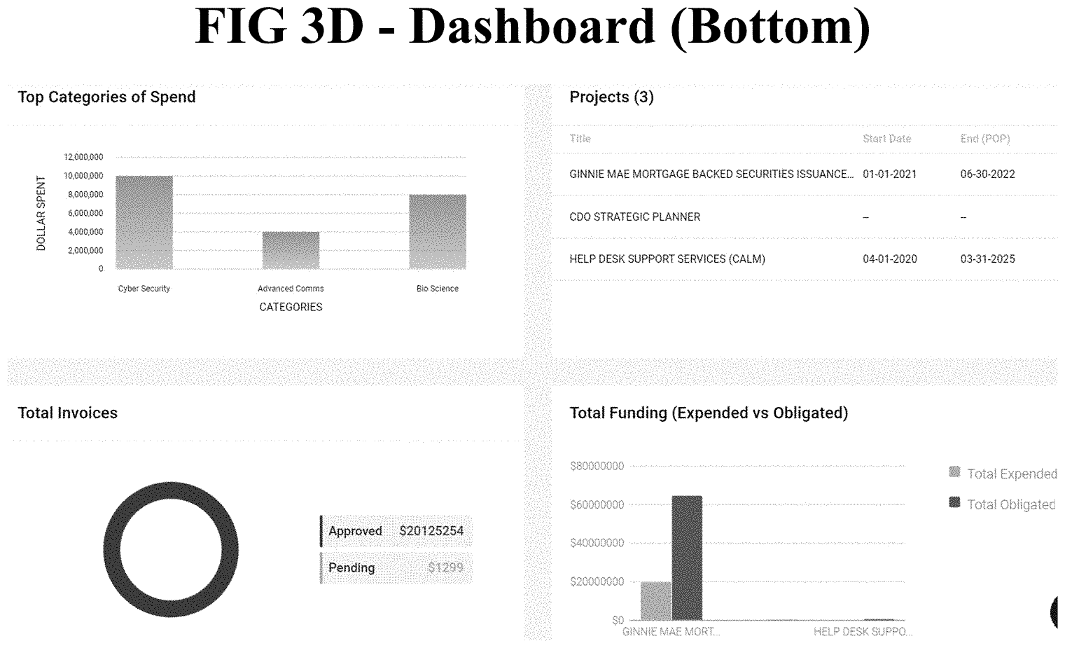

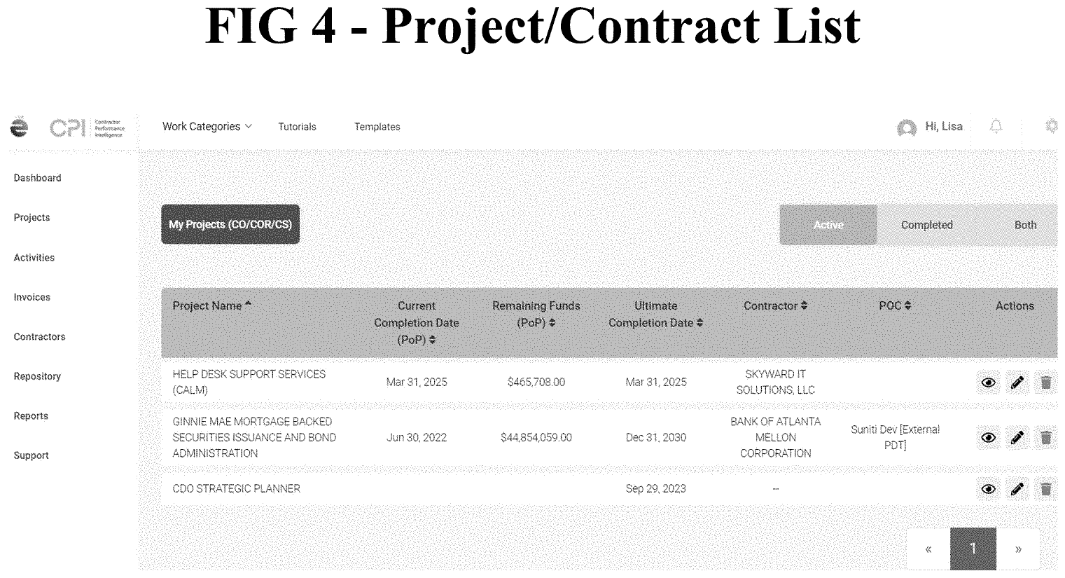

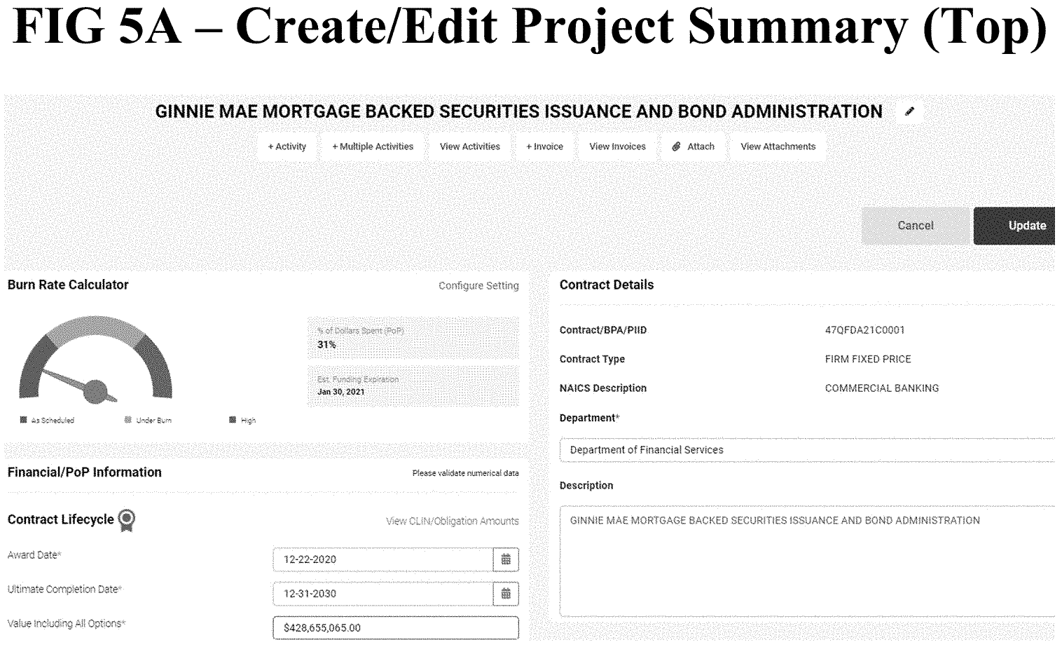

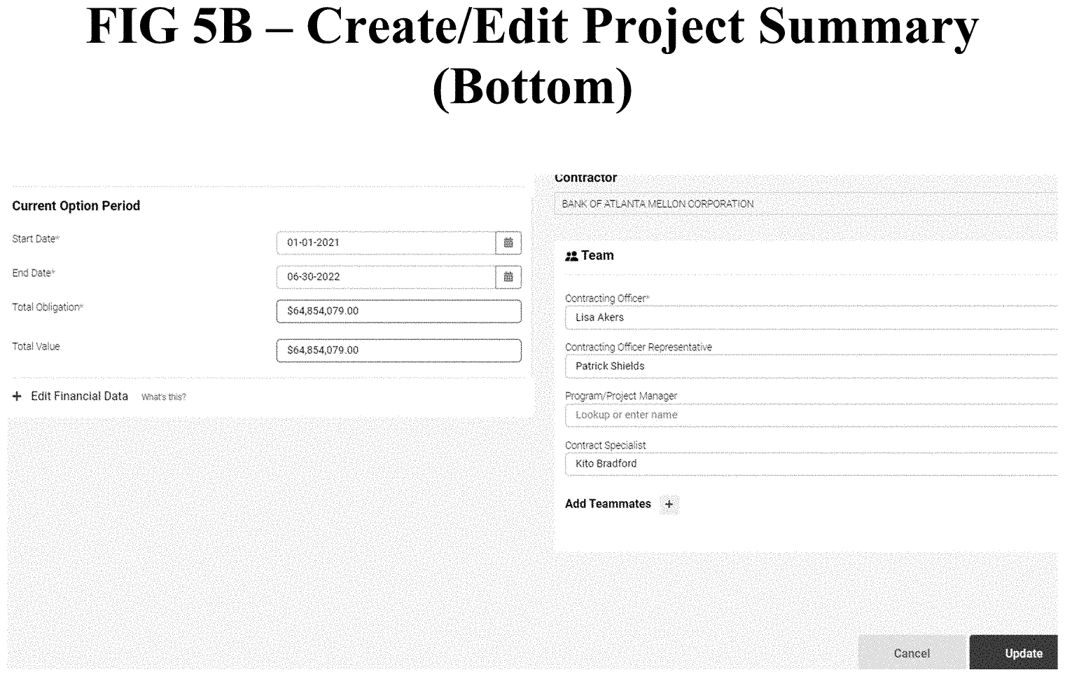

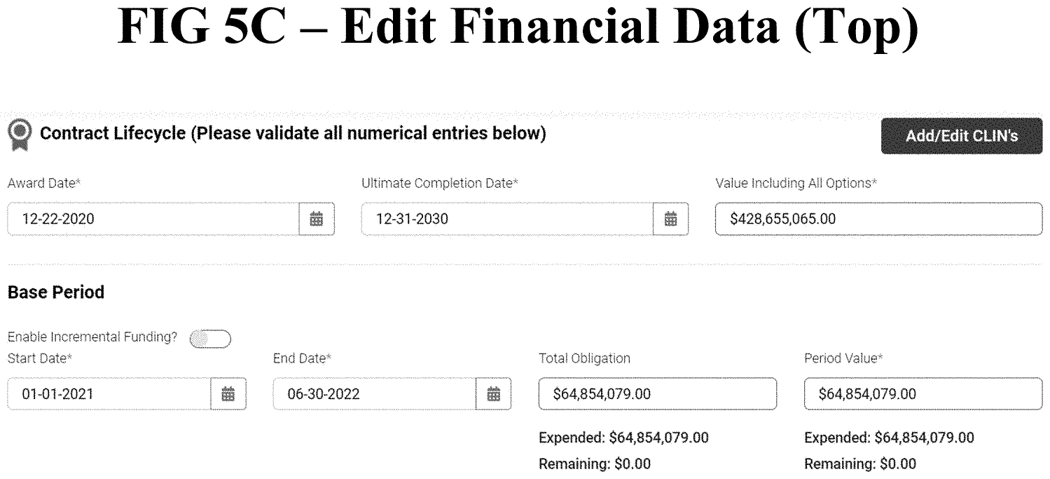

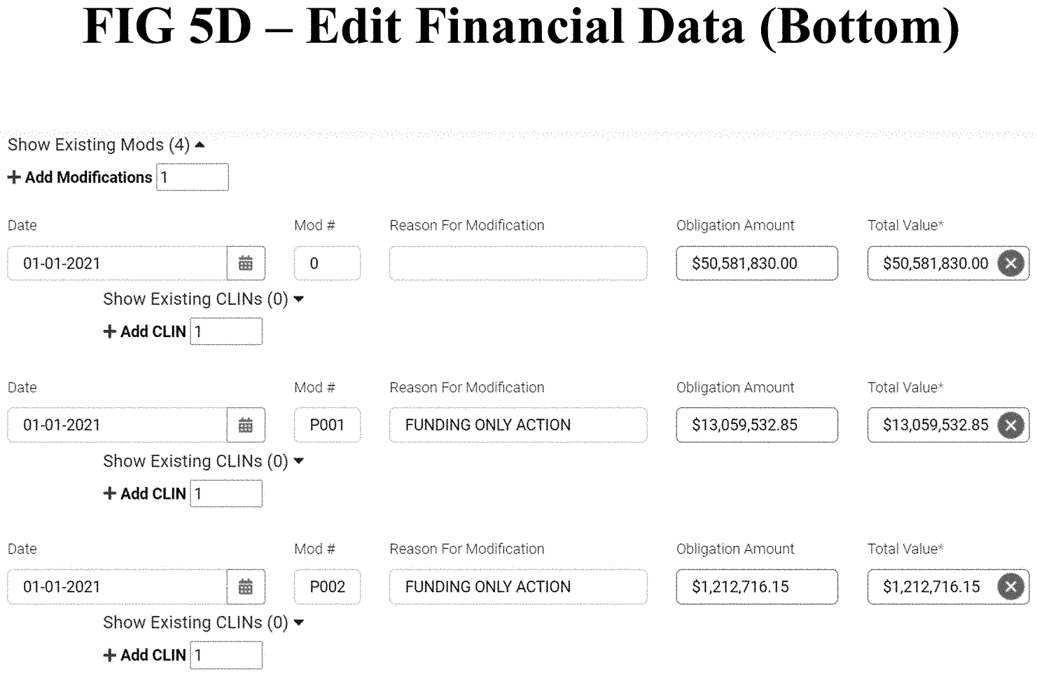

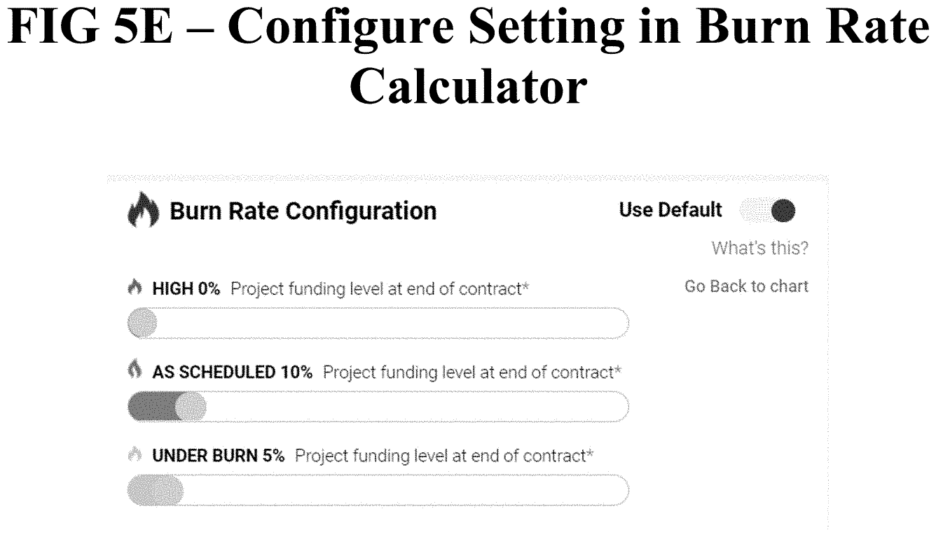

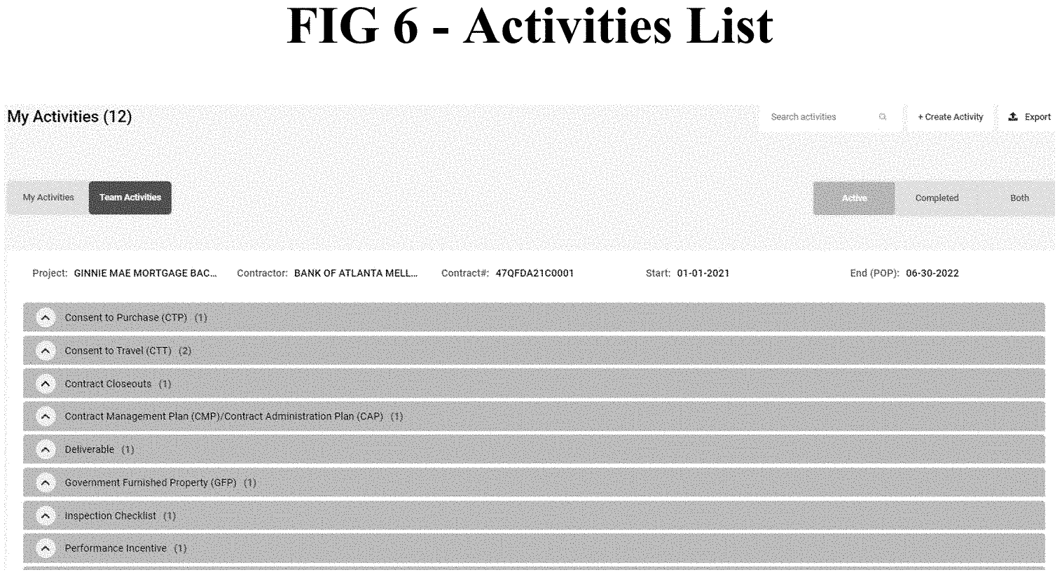

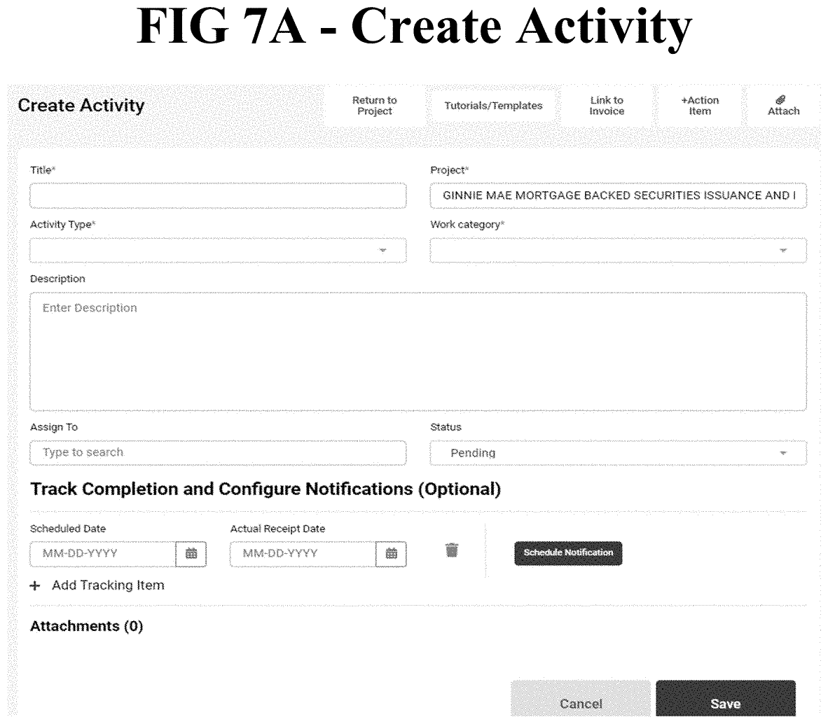

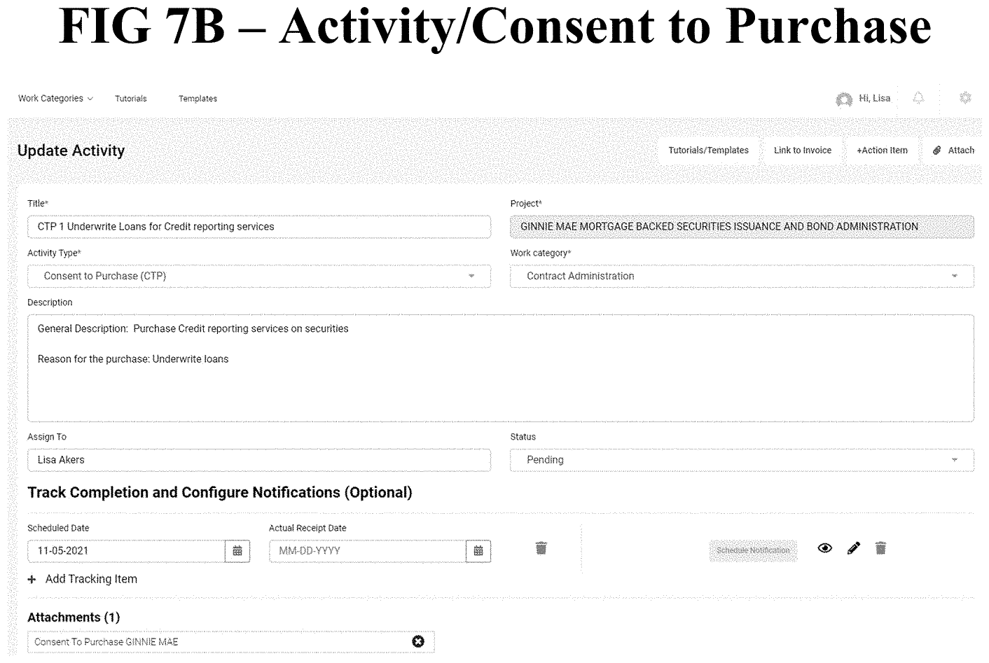

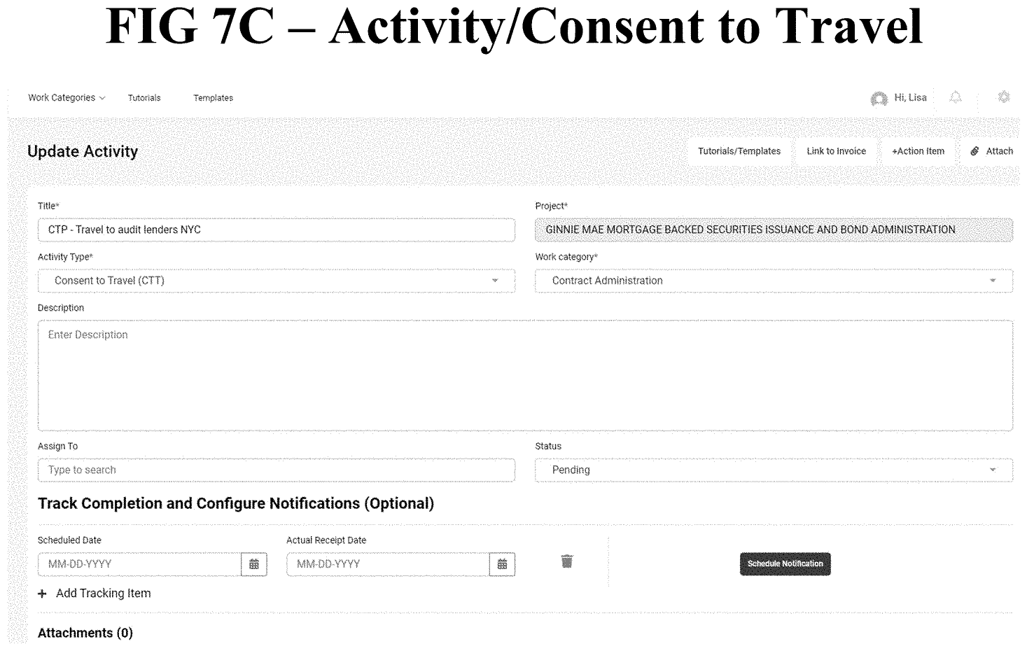

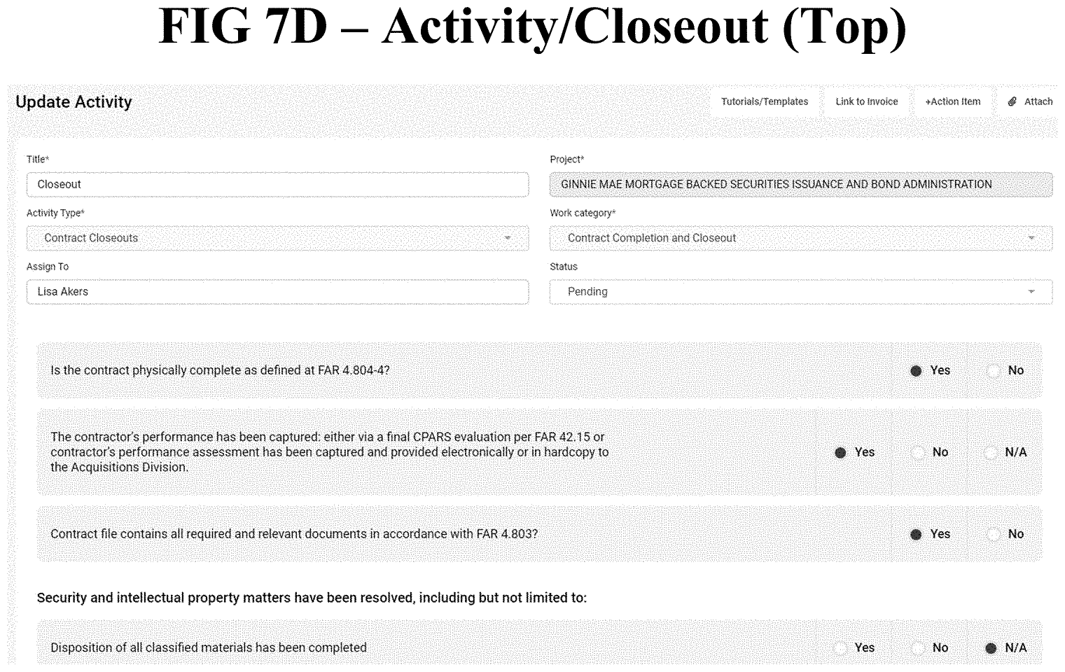

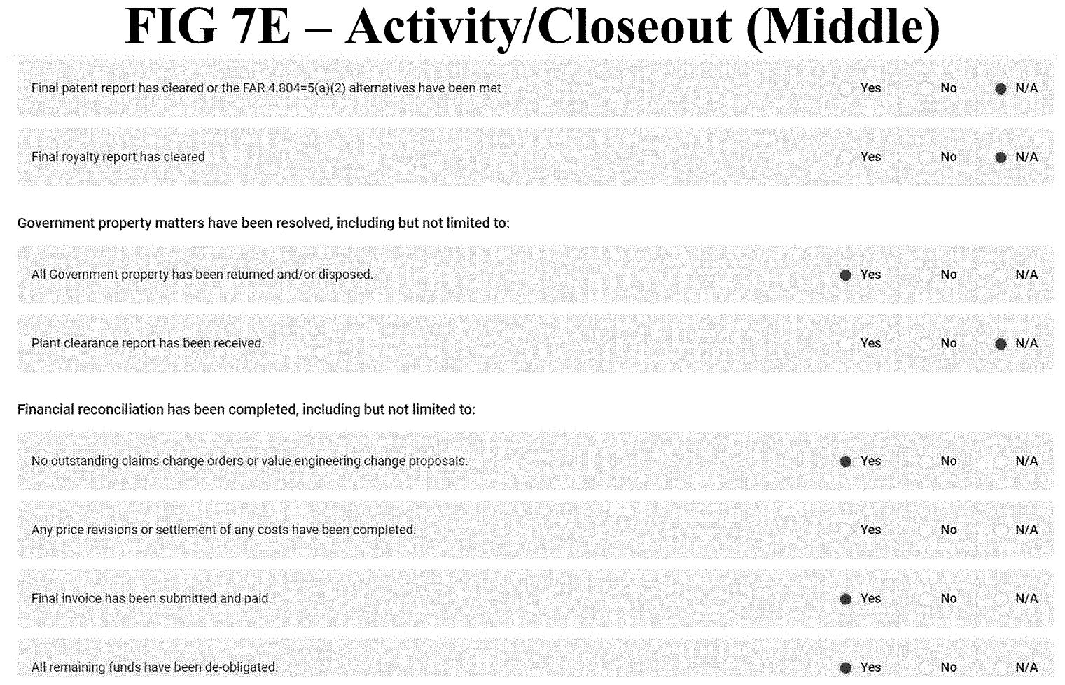

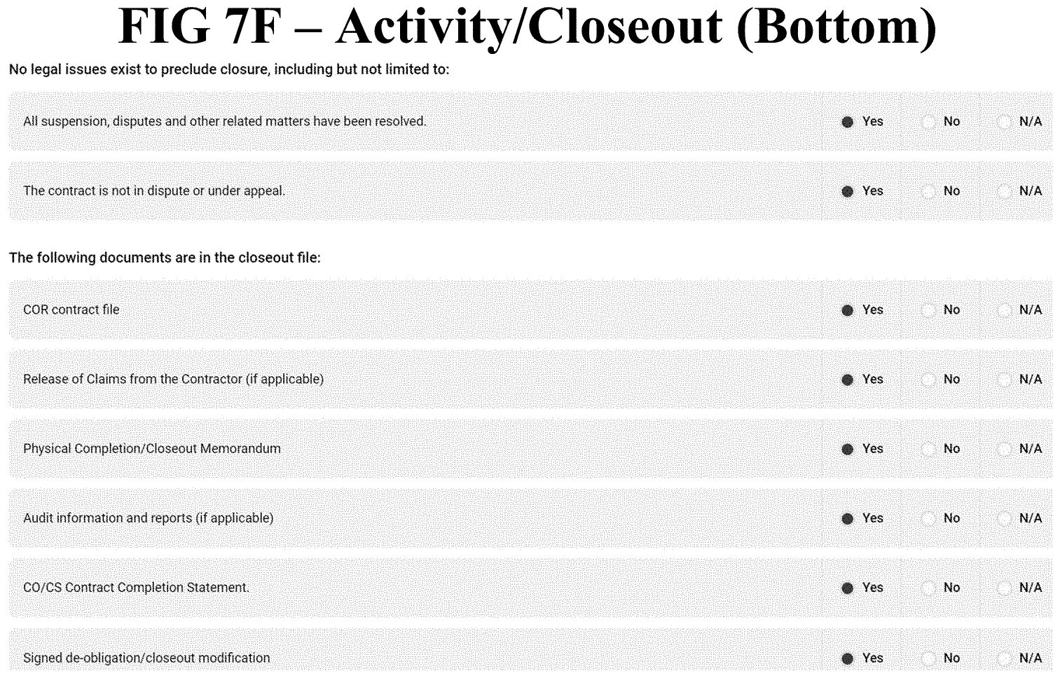

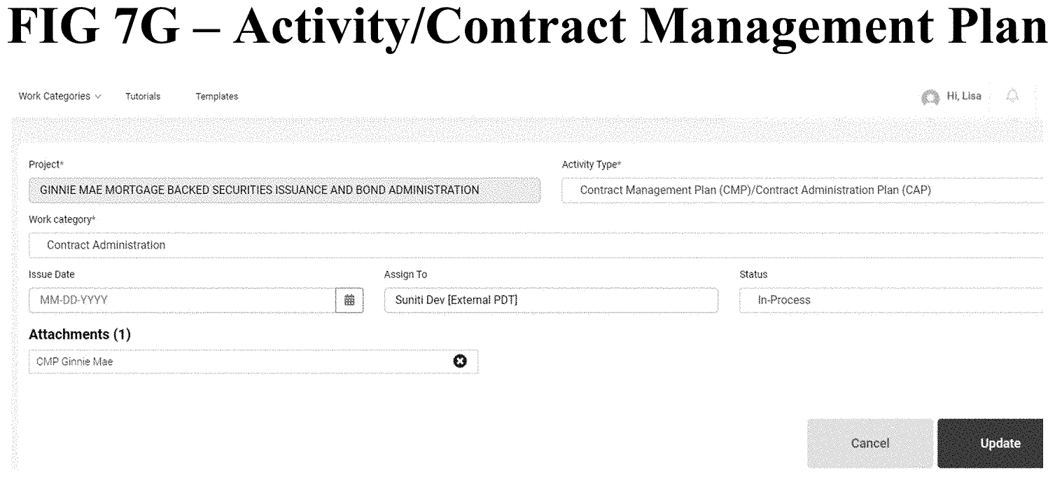

FIGS. 3A, 3B, 3C, and 3D show the system's Dashboard with system performance charts. The dashboard will show the information in charts based on the user's roles and project data access permissions.

FIG. 4 shows the system page of the list of Project/Contract when the user selects Projects in the left pane. The list of Projects shown will reflect the user's role on Projects and in the organization.

FIGS. 5A and 5B depicts the Create or Edit Project page that summarizes the main information about the contract to include the title, description, contract number, contract type, North American Industry Classification System (NAICS) code of system, burn rate settings, financial/period of performance (PoP) information, contract period, contractor name, and acquisition team members with access to the project file. The majority of this information is extracted from an API to the government's SAM.gov system that is mandatory contract reporting for all government agencies or directly to the agency's contract writing system (CWS).

FIGS. 5C and 5D show the page opens when the user selects the ‘+ Edit Financial Data’ in FIG. 5B. This page allows the user to validate and edit the contract periods and financial information that the system pulls from the API to SAM.gov or agency CWS.

FIG. 5E shows the page that opens when the user selects ‘Configure Setting’ on the Burn Rate Calculator shows in FIG. 5A. The user can set the cost expenditure rate, commonly referred to as Burn Rate, that is appropriate for the project funding cycle and the amount of time required for the agency to add additional funding or take corrective action if the contractors has high burn rate of project funds. The user will configure the thresholds for high, as schedule and under burn then Go Back to the Chart on the Project page.

FIG. 6 depicts how the system displays Activities List when the user selects Activities in the left navigational pane shown in FIG. 3A and FIG. 4. The activities are grouped by project and can be filtered by activity status: active, completed, or both. This activity view allows the user to quickly select the activity within a project that needs attention.

FIG. 7A depicts the page when the user chooses to Create Activity from FIG. 5A Create/Edit Project Summary or FIG. 6 Activities List. If the user selects Create Activity from 5A, the activity will be related to that project. If the user selects Create Activity from the Activity List, the user will need to select the project. All new activities require a title, project, activity type. The work category will appear after the activity type is chosen. Optional fields are the description of the activity, assignment, and status. The user has the option to configure and track competition of notification related to the activity; these notifications ensure that the activities are completed in a timely manner in accordance with the schedule and requirements.

FIG. 7B through FIG. 7Y show the pages and information related to specific types of Activities that government users perform related to contract management and oversight.

FIG. 7B collects the summary information about the Activity—Consent to Purchase which is the contractor's request to purchase supplies or services using government funds on cost reimbursable CLIN, tracks government approval and allows the COR to link the consent to purchase to a subsequent invoice(s) submitted by the contractor.

FIG. 7C collects the summary information about the Activity—Consent to Travel contractor's request to travel using government funds on cost reimbursable CLIN, tracks government approval and allows the COR to link the consent to travel to a subsequent invoice(s) submitted by the contractor.

FIGS. 7D-7F show the Activity—Contract Closeout request which guides the user through complex steps involved in preparing for the contract closeout in accordance with federal acquisition regulations. The user attaches all relevant documents and submits the final closeout package with the closeout process checklist to the CO for execution. Since contract closeouts can be delayed for 2-10 years after the contract ends, this activity documents the status of the closeout procedures for future execution when the COR and CO may no longer be available.

FIG. 7G depicts the Activity—Contract Management Plan information to ensure that a copy of the plan is available throughout the life of the contract to any team member assigned.

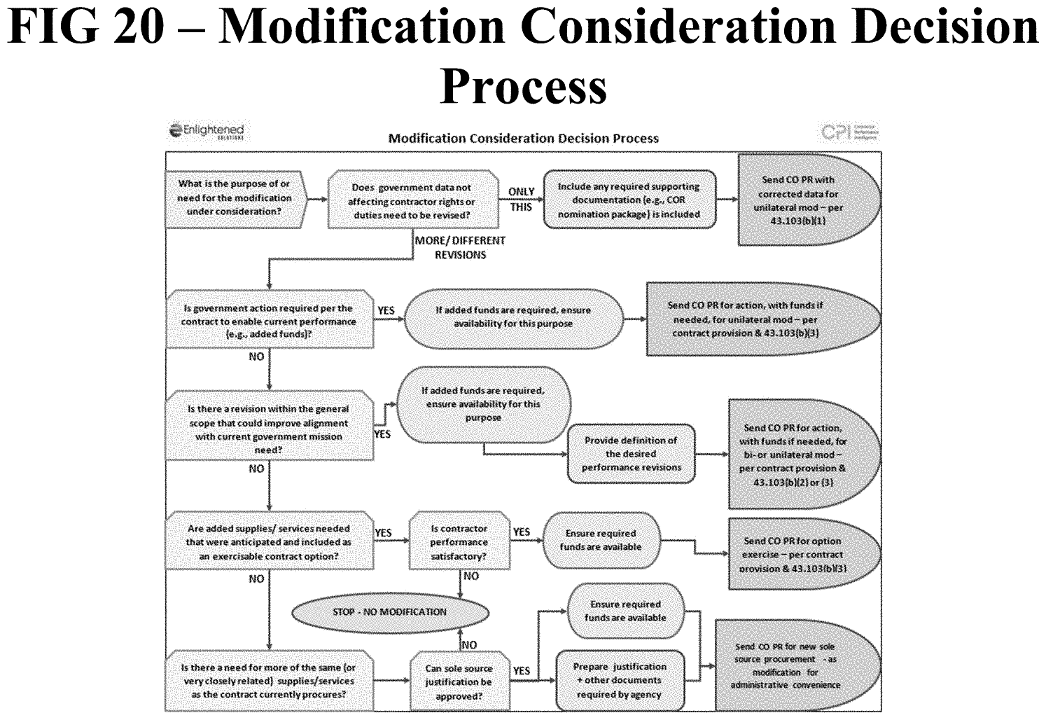

FIG. 7H Activity—Modification Select Type is intelligent process automation programmed into the system to guide the user through the Modification Consideration Decision Process that is expanded in FIG. 20 later in this document. Depending on the modification type selected by the user, the system asks the user additional questions that shape the steps necessary to complete the modification.

FIGS. 7I-7M show how the process automation is configured based on the five types of contract modifications shown in FIG. 7H: revised information (administrative changes); add/de-obligate funds; within general contract scope; additions to requirements; change COR. Upon completion of the appropriate steps and creation of required documentation, the system packages the contract modification request to send to the CO.

FIG. 7N shows the Activity—Deliverables when the user sets up the scheduled deliverables required by the contract. Since a single contract can have one to hundreds of required deliverables, the system supports the tracking of the dates each deliverable is due, toggle if government comments are required so those dates are also tracked, and allows for easy distribution of the deliverables to all acquisition team members through the repository and the deliverables notification function.

FIG. 7O shows the Activity—Government Furnished Information and Property used to track and recover information and property provided to the contractor to enable performance under the contract. This is required for contract close-out, so it is important part of official COR files.

FIG. 7P shows the Activity—Inspection Checklist used to track the establishment and collection of inspection procedures for required supplies and services under the contract.

FIG. 7Q shows the Activity—Performance Incentive that relates to managing performance-based contracts where the government identifies the incentives, evaluates the contractor's performance against those measures, and pays out for approved incentives. The system collects the plan, contractor self-assessment and government evaluations through this activity and allows the evaluations to be associated with invoices for the incentive pay.

FIG. 7R shows the Activity—Post—Award Orientation that is the official kick-off of the contract where the government and the contractor meet to lay out expectations, discuss any concerns, discuss funding and schedules. This system activity supports the planning and documentation of the post-award orientation meeting by allow notifications to all members of the acquisition team, scheduling the meeting, and attaching the files. Action items coming out of the meeting are created under the activity and provide date and status tracking.

FIG. 7S shows the Activity—Quality Assurance Surveillance Plan (QASP) that is how the government surveils the contractor's quality assurance plan to provide supplies and services that meet quality requirements in the contract. The system allows all members of the acquisition team to have access to the QASP over the life of the contract. This activity provides input to the government's assessment of the contractor's performance under the next activity FIGS. 7T-7V.

FIGS. 7T-7V depict the Activity—Contractor Performance Assessment Rating System (CPARS) which the government is required to provide annual and final evaluations for all contractors' performance on contracts above the simplified acquisition threshold. The system allows the user to attach interim notes to the CPARS and set up reminders prior to the contract period ending. The CPI system automatically pulls the contract information for the user streamlining the collection and the user simply enter performance related ratings to package for submission to CPARS,

FIG. 8 shows the existing activities under the selected project. The user can select the activity to view, edit or delete the activity.

FIGS. 9A and 9B show the list of invoices under the projects that will appear when the user selects Invoices in the left navigational pane shown in FIG. 3A and FIG. 4. The user can select an invoice to view or edit. The Invoice List can be used to create a new invoice.

FIG. 10 shows the page displayed when the user wants to create an invoice. The user captures the details related to validate the invoice is within the contract period, value within the contract line item number (CLIN) ceilings, due date, status, received data and due date. Financial management systems do not capture the level of detail needed to manage and oversee contractor's use of government funds at the CLIN level, contract terms, and the period of performance which is the reason why CPI system captures, track spending to monitor burn rate and prevent exceeding the contractual limits.

FIG. 11 shows the list of Contractors and the awarded projects that will appear when the user selects Contractors in the left navigational pane shown in FIG. 3A and FIG. 4. The user can select a contractor or project to view or edit. Depending on the access level, the user can filter to see my contractors or all contractors they have access permissions to view. The Contractor list can be used to view and update contractor point of contact information. The Contractor list can be used to assess the impact if a Contractor was experiencing performance or financial issues that may cause risk to government mission across multiple contracts. The contractor information is provided through API to the CWS or the government wide SAM.gov system.

FIG. 12 show the Repository of all activities by projects that will appear when the user selects Repository in the left navigational pane shown in FIG. 3A and FIG. 4. The user can search the repository to find samples of other documents that the user has access permissions. The repository can be used to audit COR files to ensure that they are complete and up-to-date.

FIG. 13A show the Reports that will appear when the user selects Reports in the left navigational pane shown in FIG. 3A and FIG. 4. The system provides four reports commonly used by the government to manage contractor performance. Reports can be Additional reports are configurable based on the users' needs.

FIG. 13B is an example of the Reports functionality that allows the user to sort by any column, search the report, and export the report findings to a spreadsheet or .pdf file for use outside the system.

FIG. 14 depicts the video tutorials available when the user selects Tutorials on the top navigational bar. On the tutorial card, the user is shown a thumbnail image of the Tutorial topic with a description of the video below. The user is able to search the tutorials to find topics based on the title, description or the meta tags associated with the tutorial. The system administrator has permissions to upload, edit and delete tutorials.

FIG. 15 depicts the templates available when the user selects Templates on the top navigational bar. On the template card, the user is shown a title of the Templates with a description of the template below and the option to download the template. The user is able to search the templates to find topics based on the title, description or the meta tags associated with the templates. The system administrator has permissions to upload, edit and delete templates.

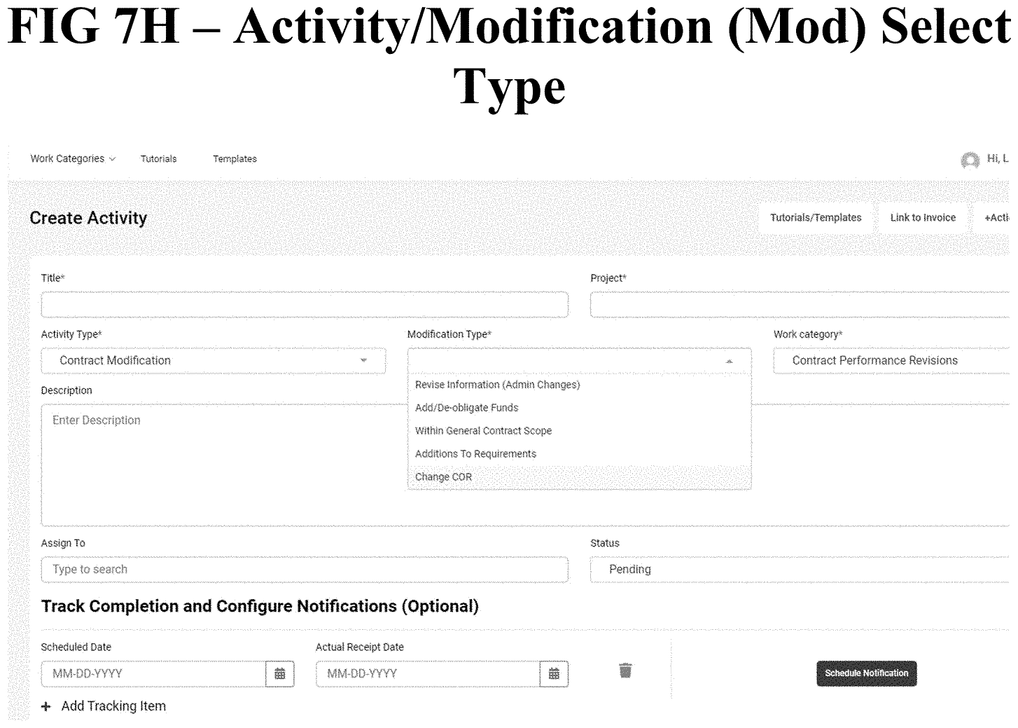

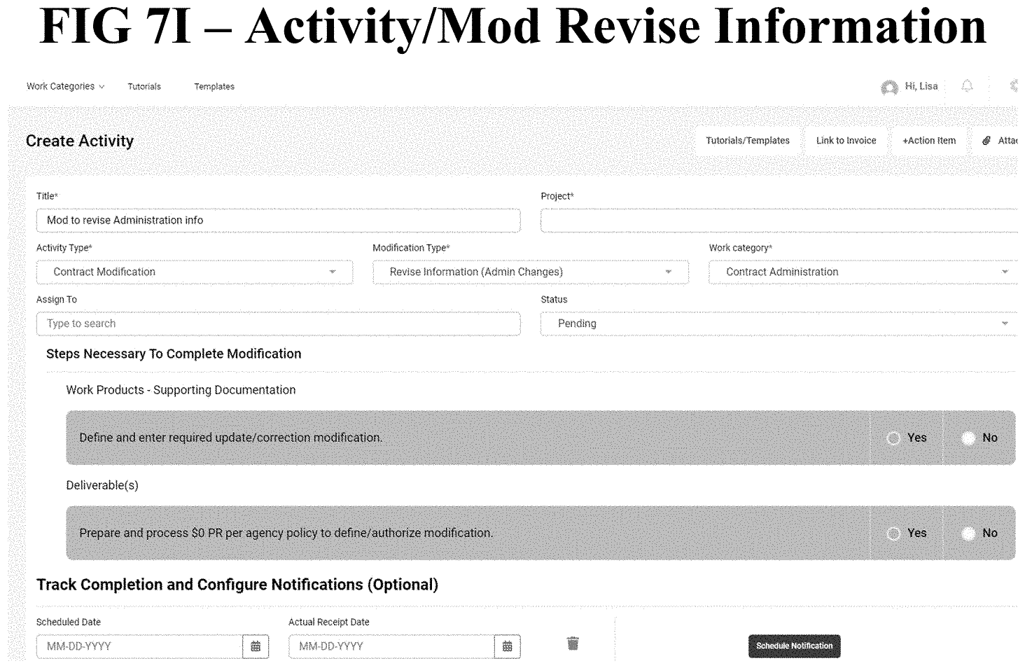

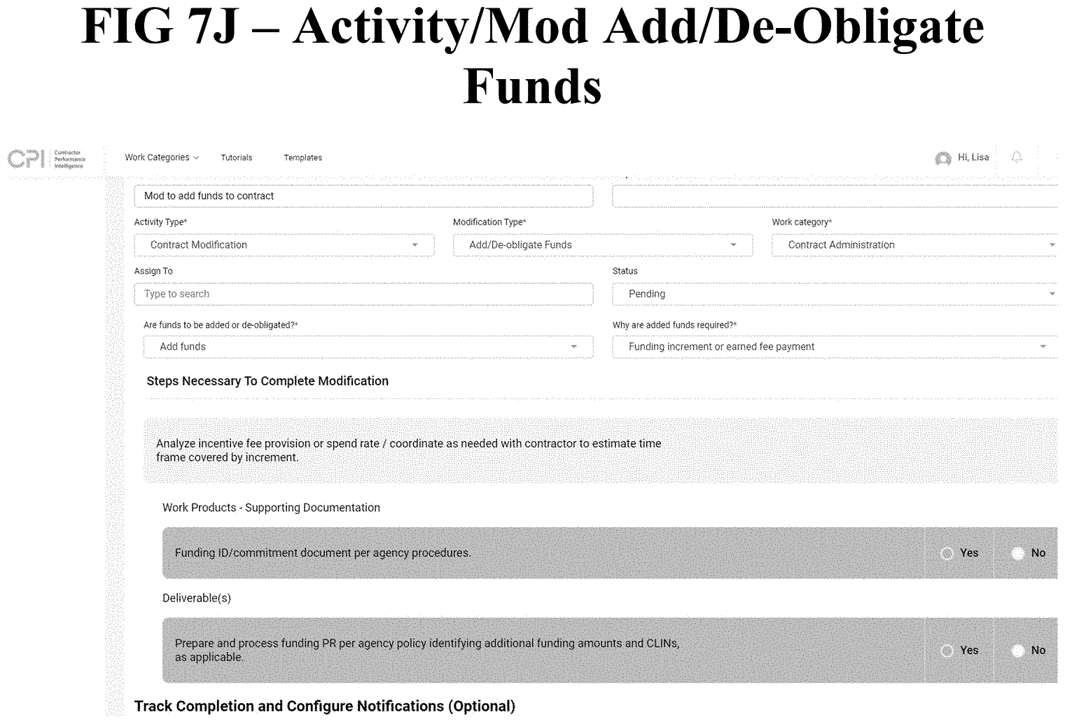

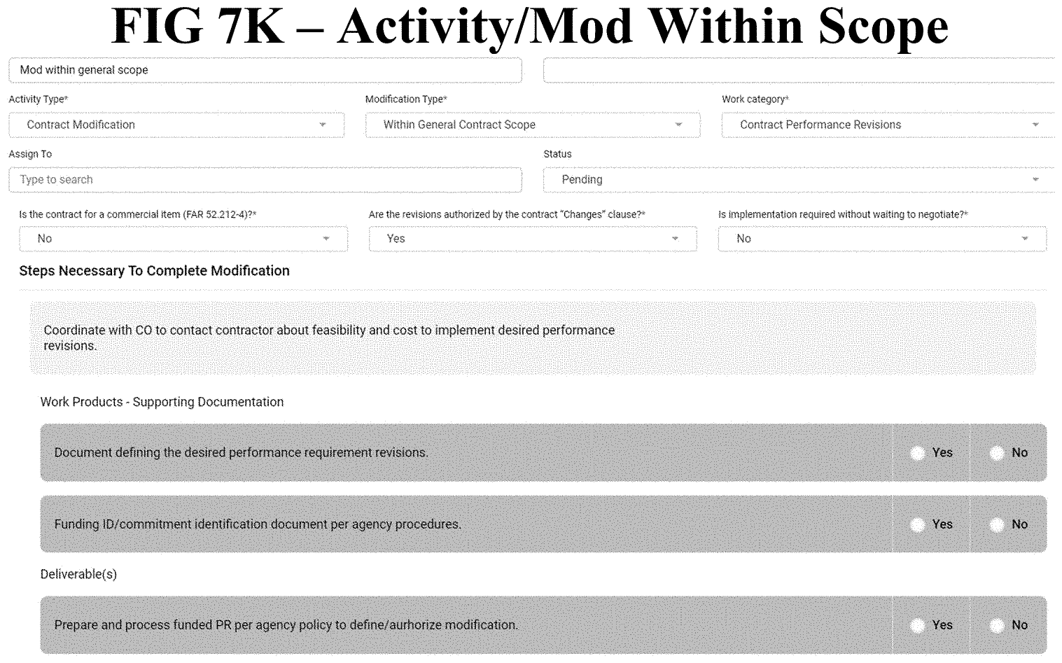

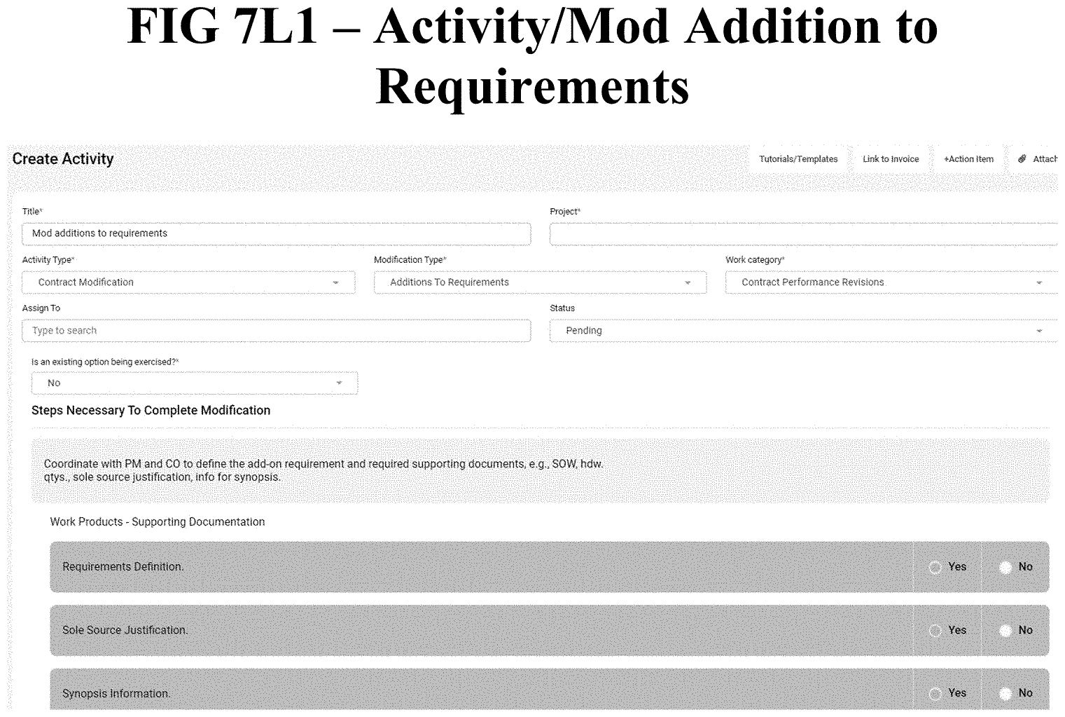

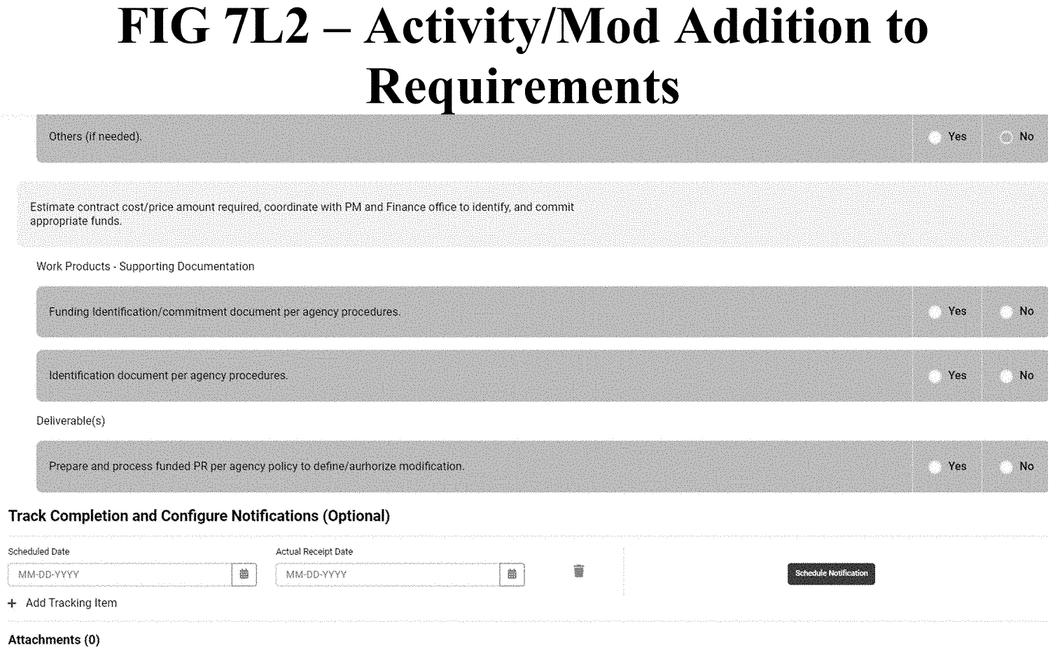

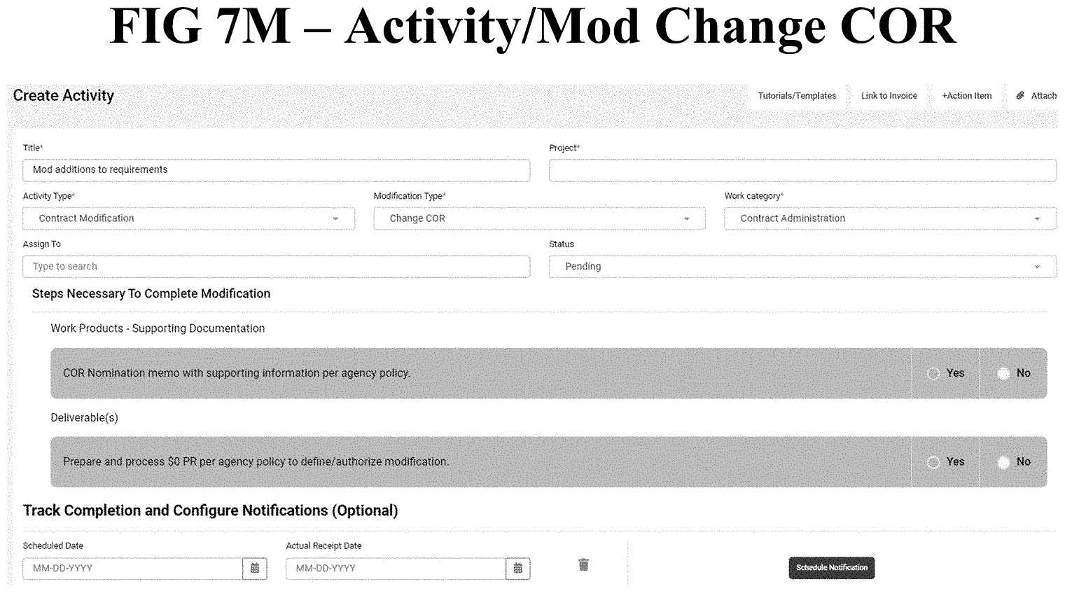

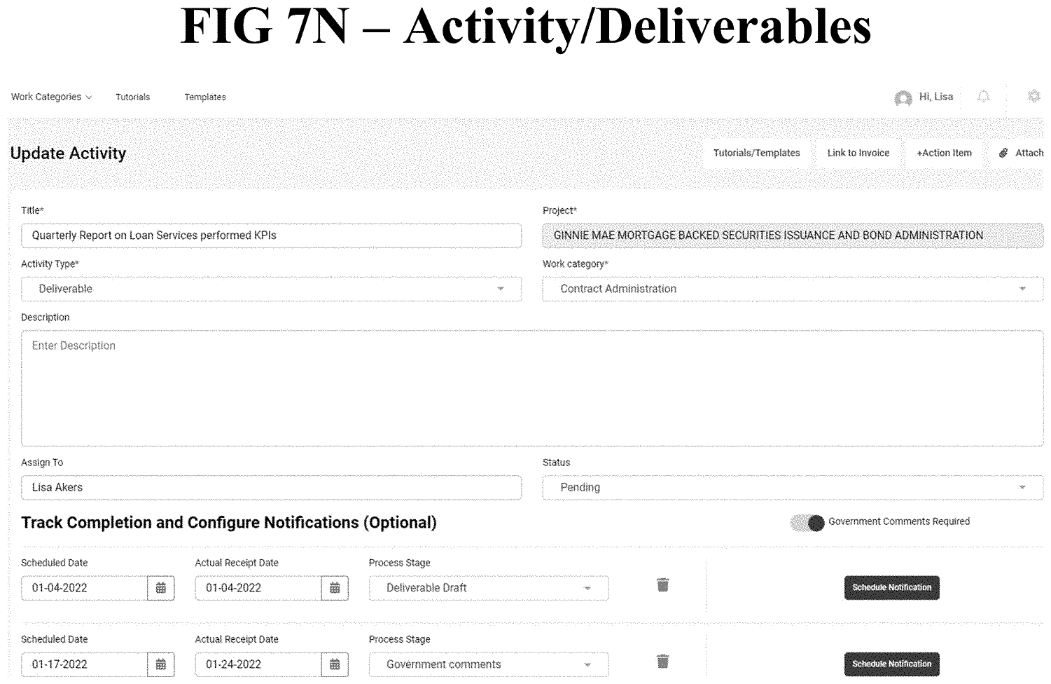

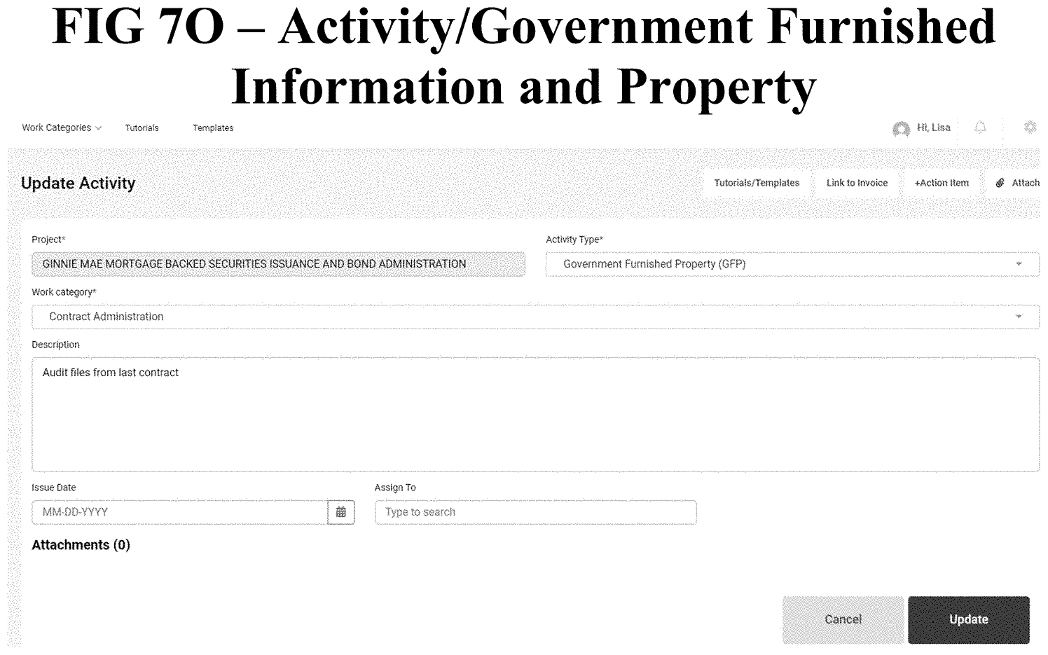

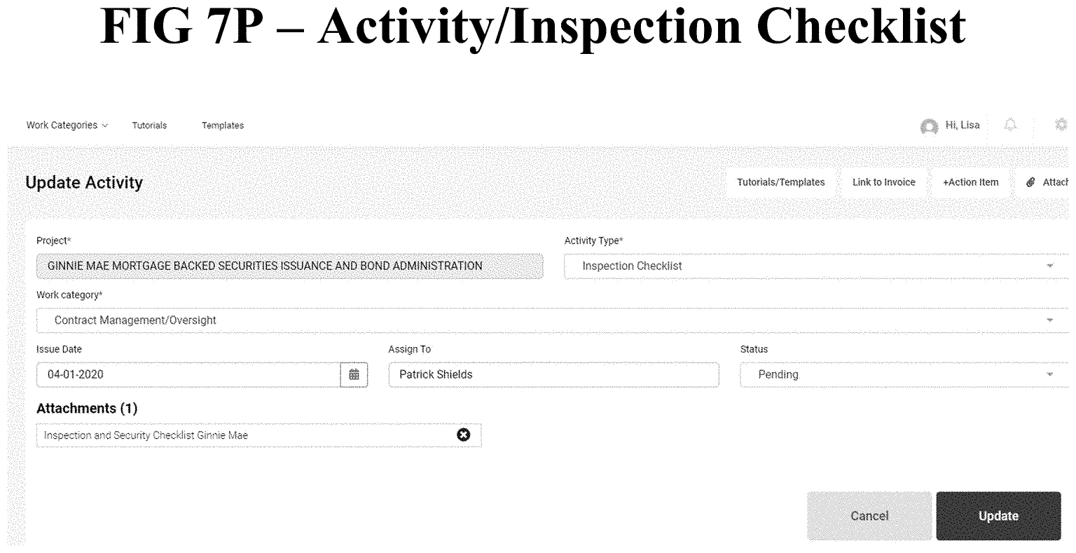

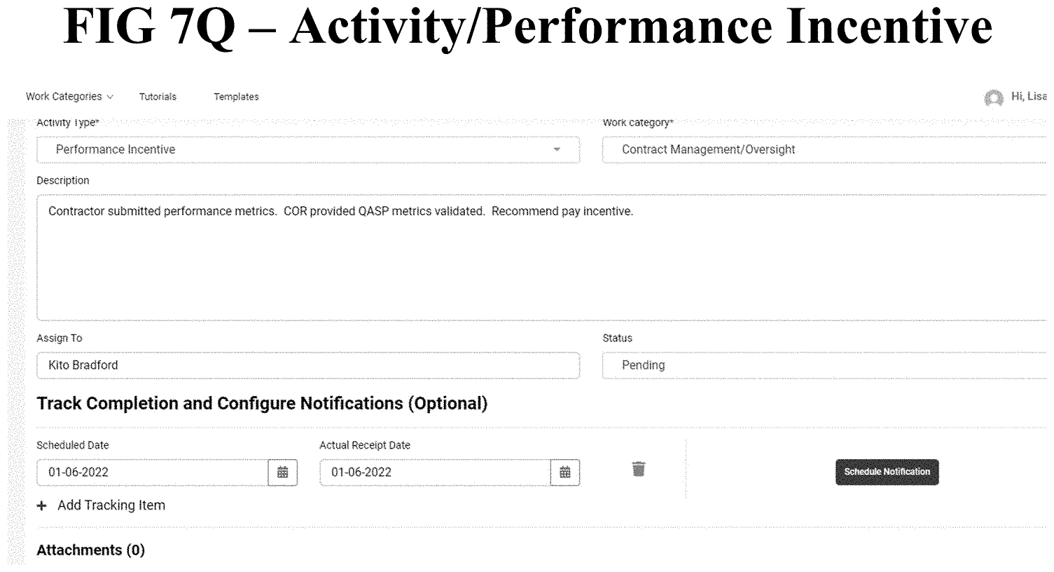

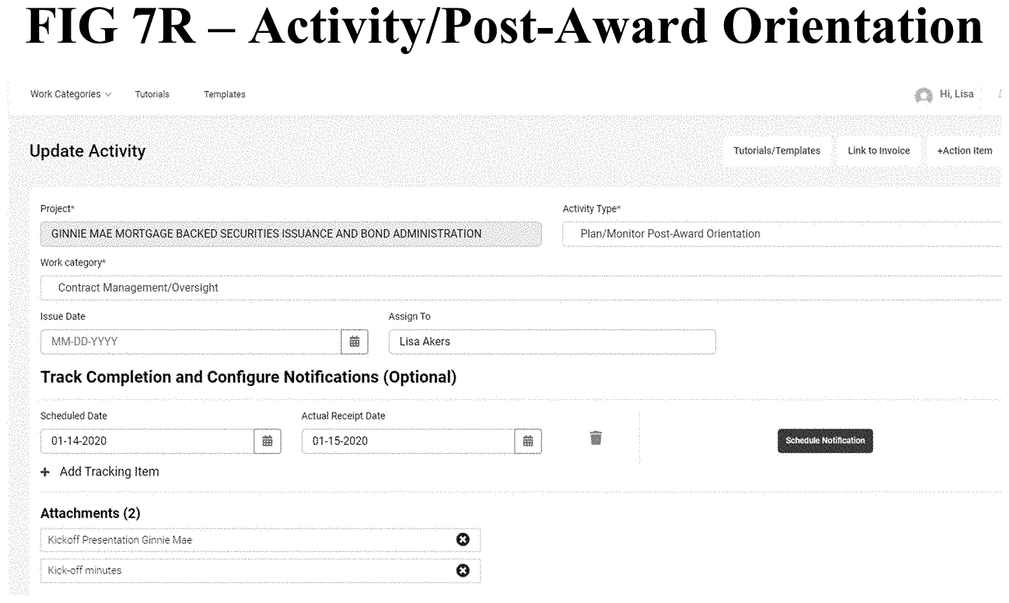

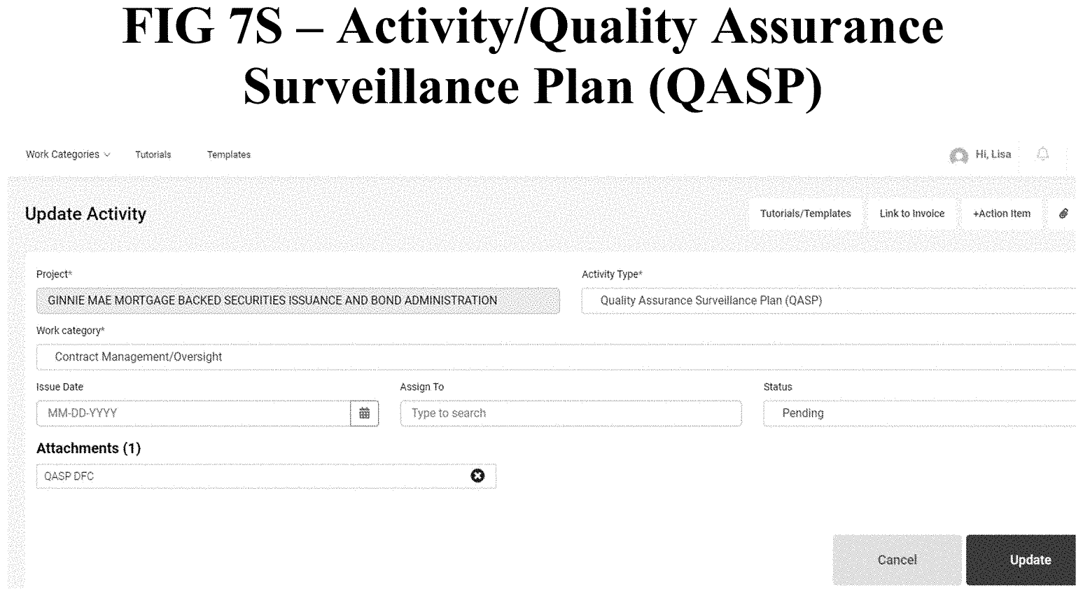

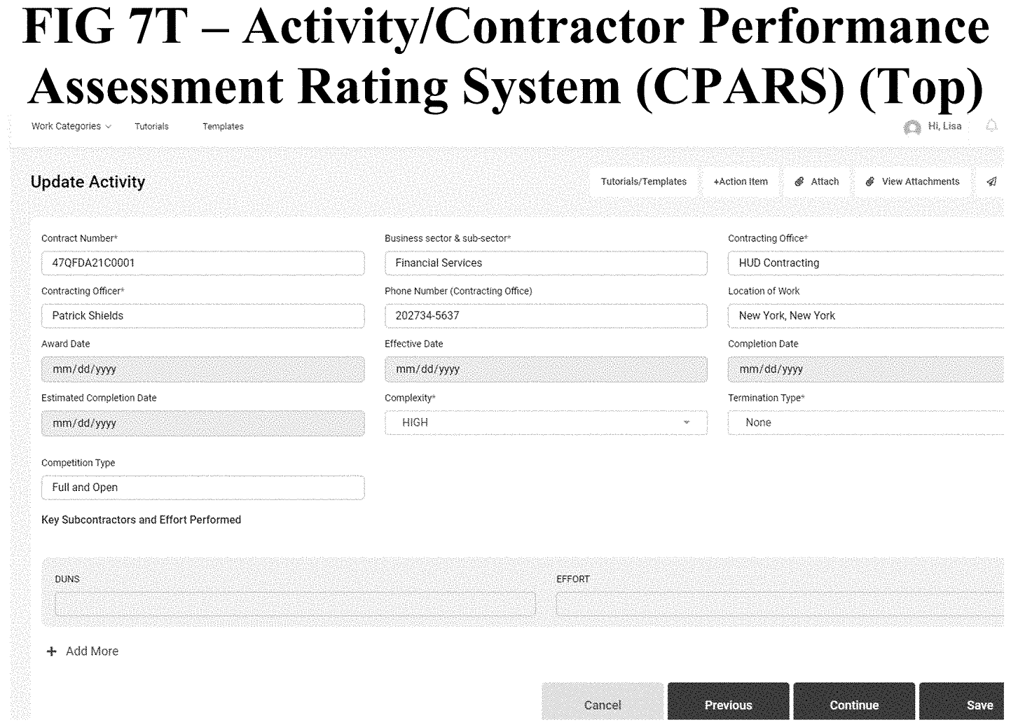

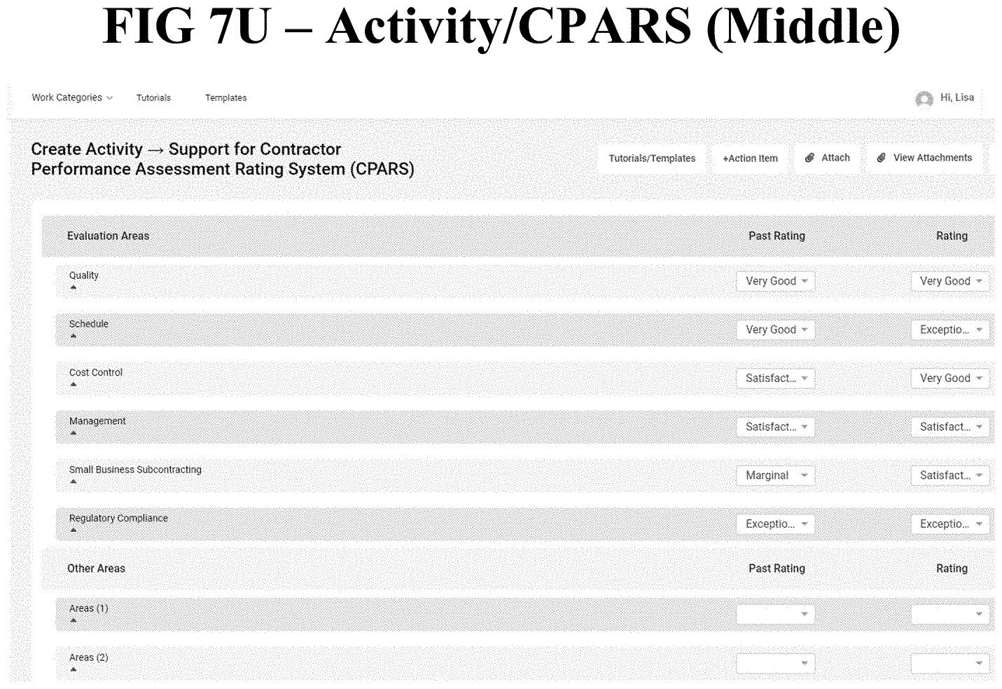

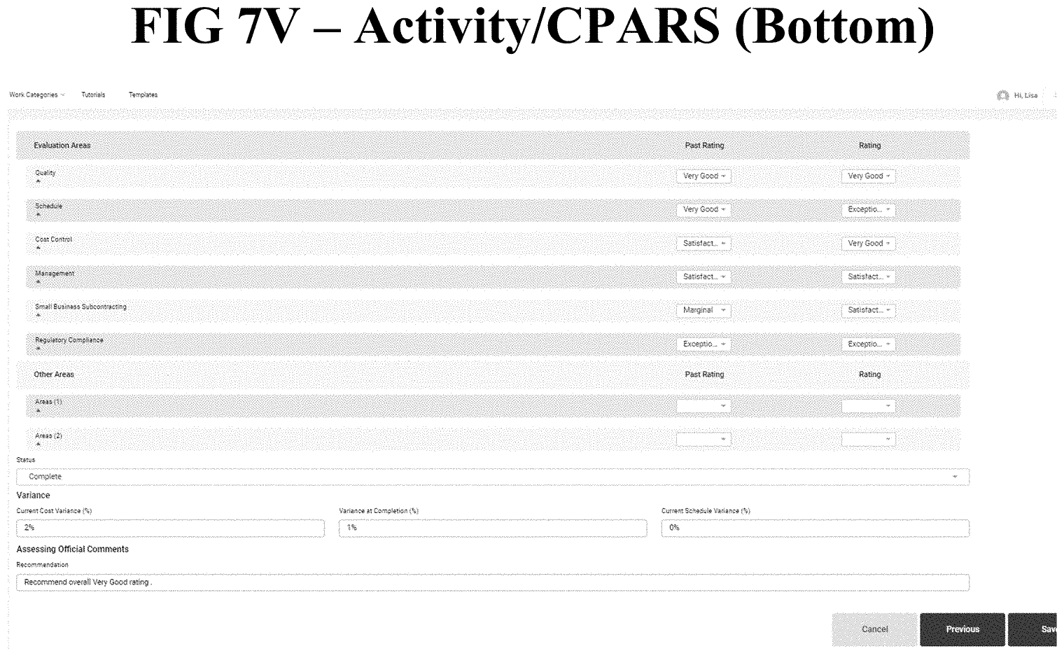

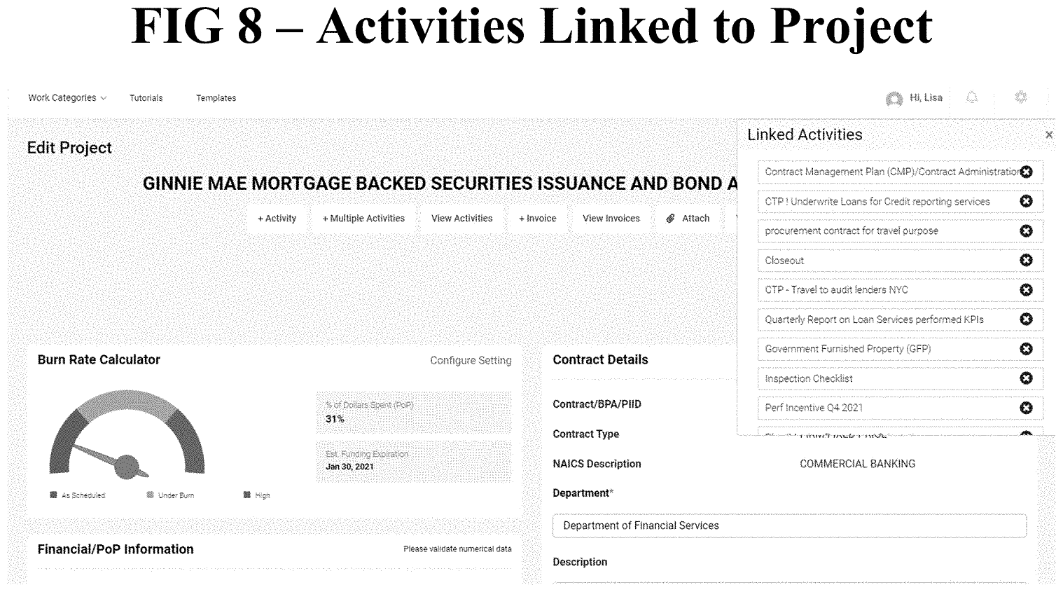

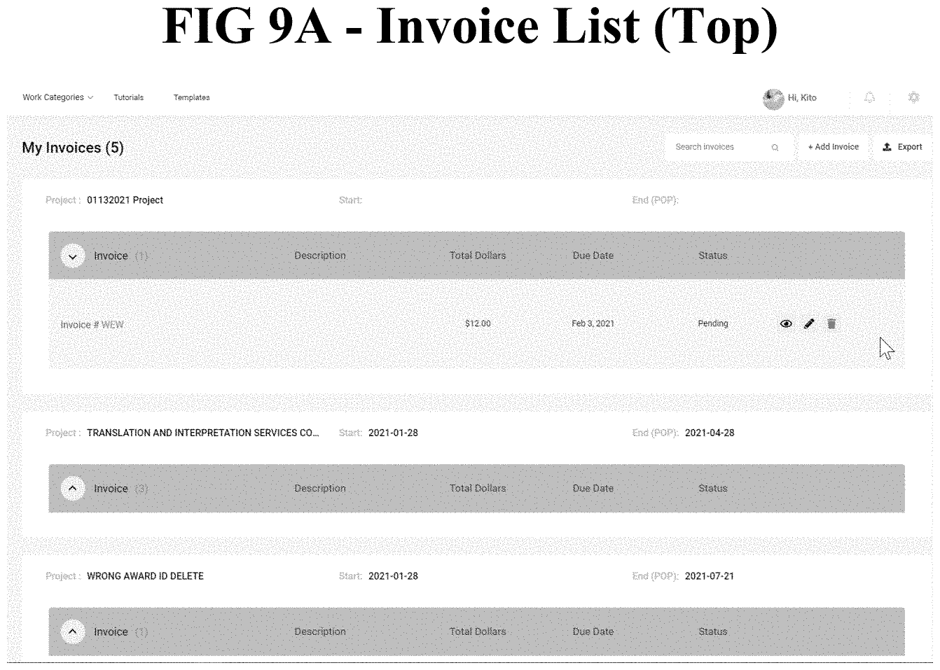

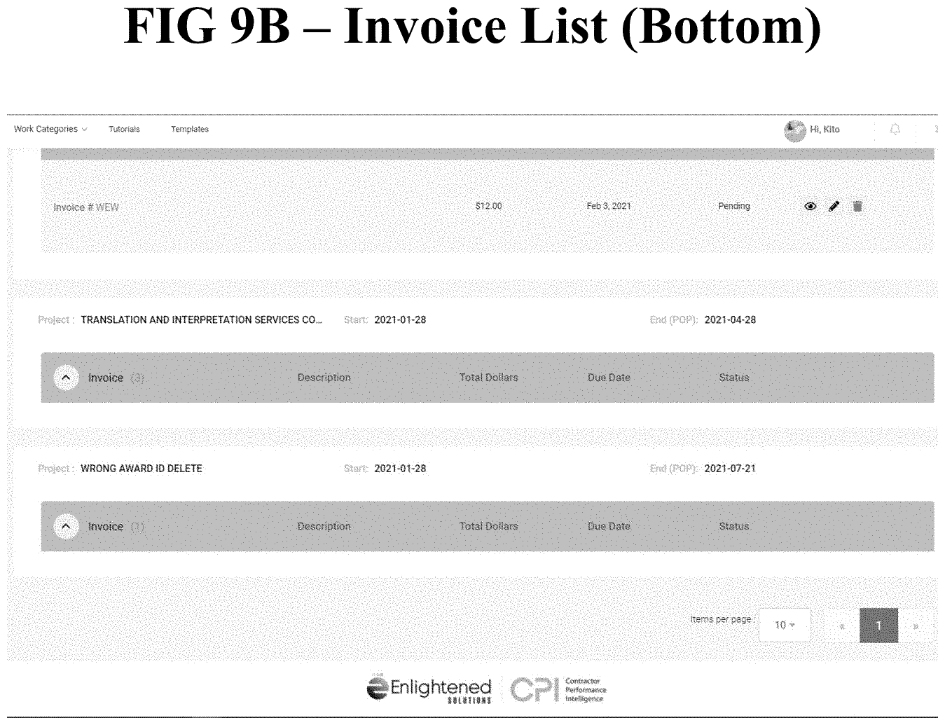

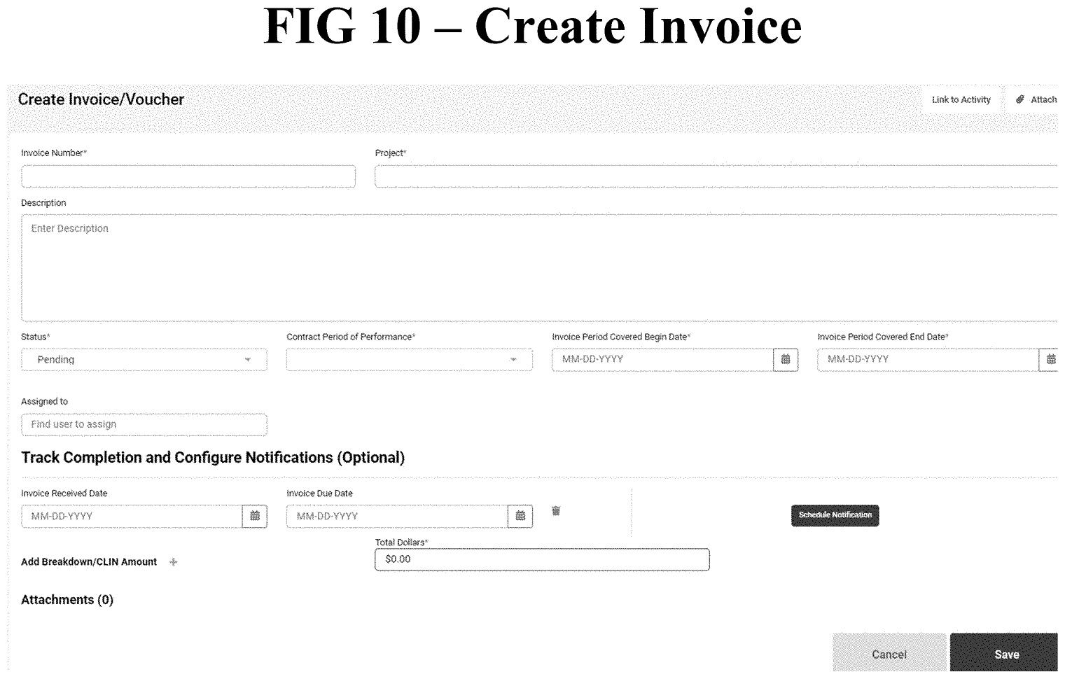

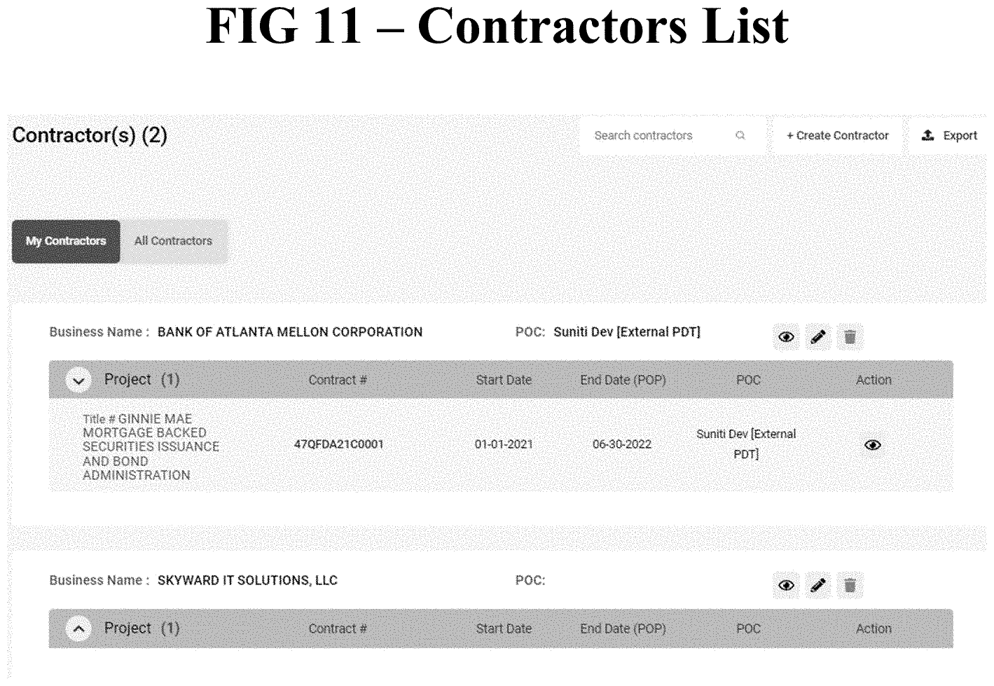

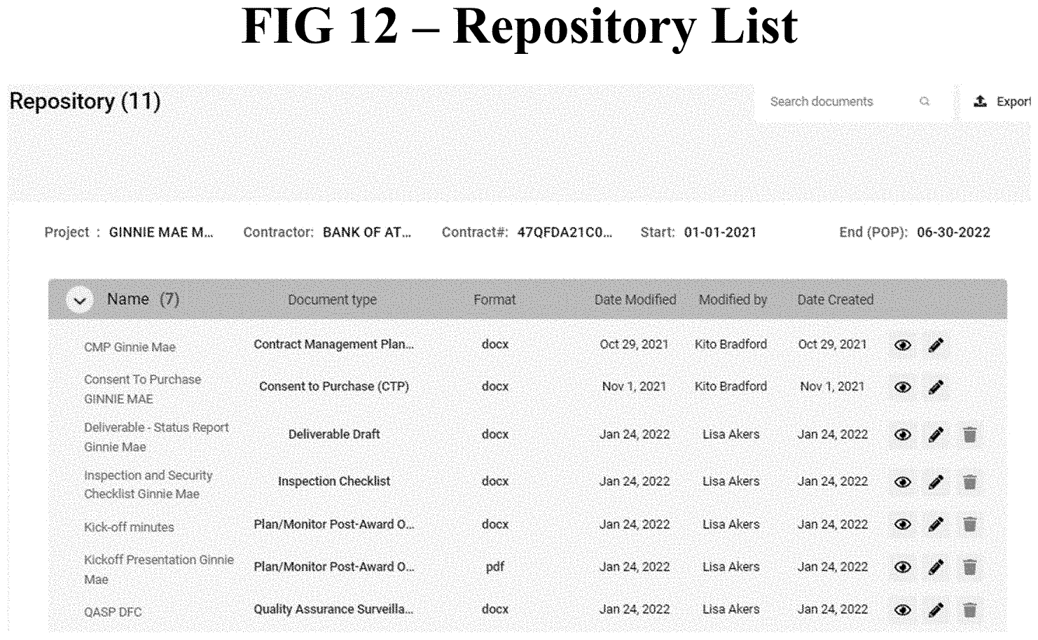

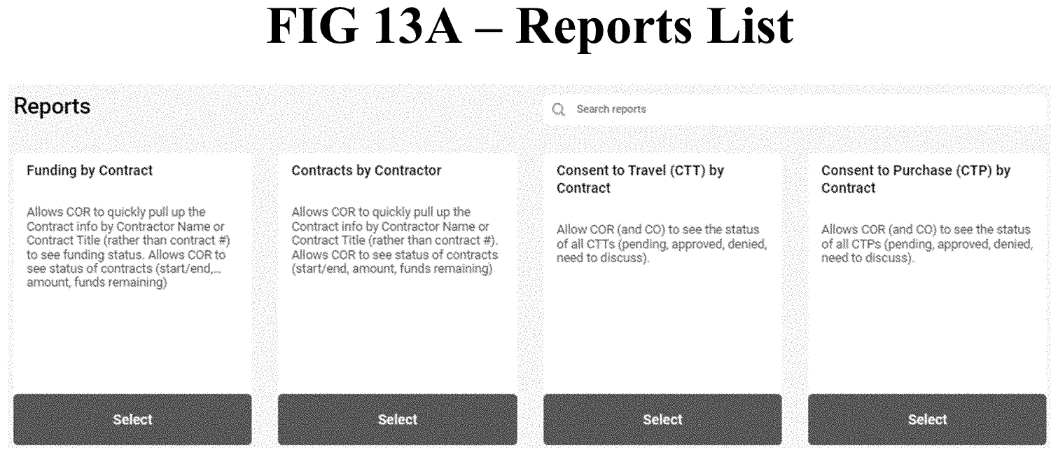

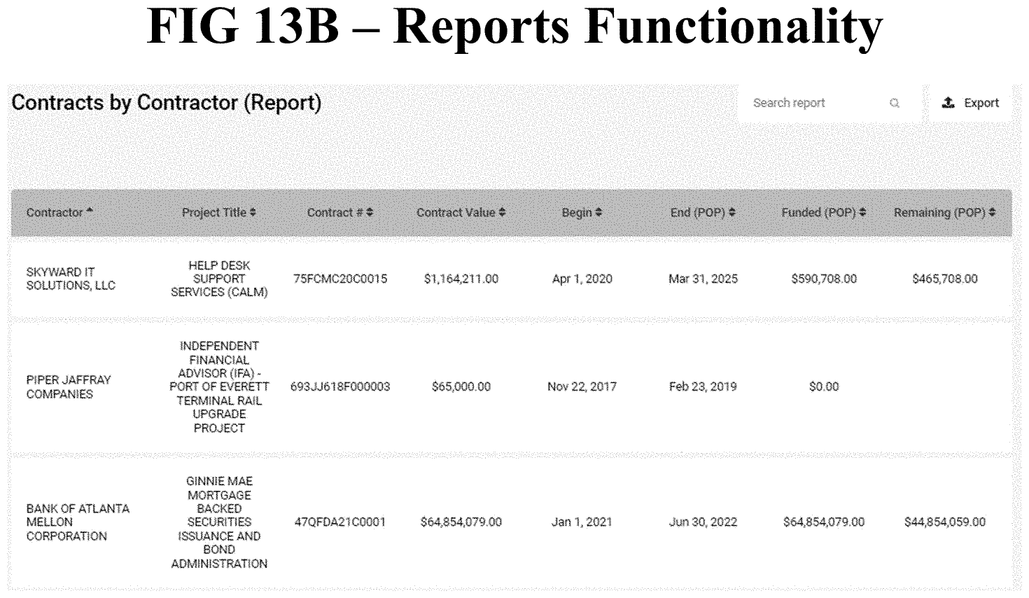

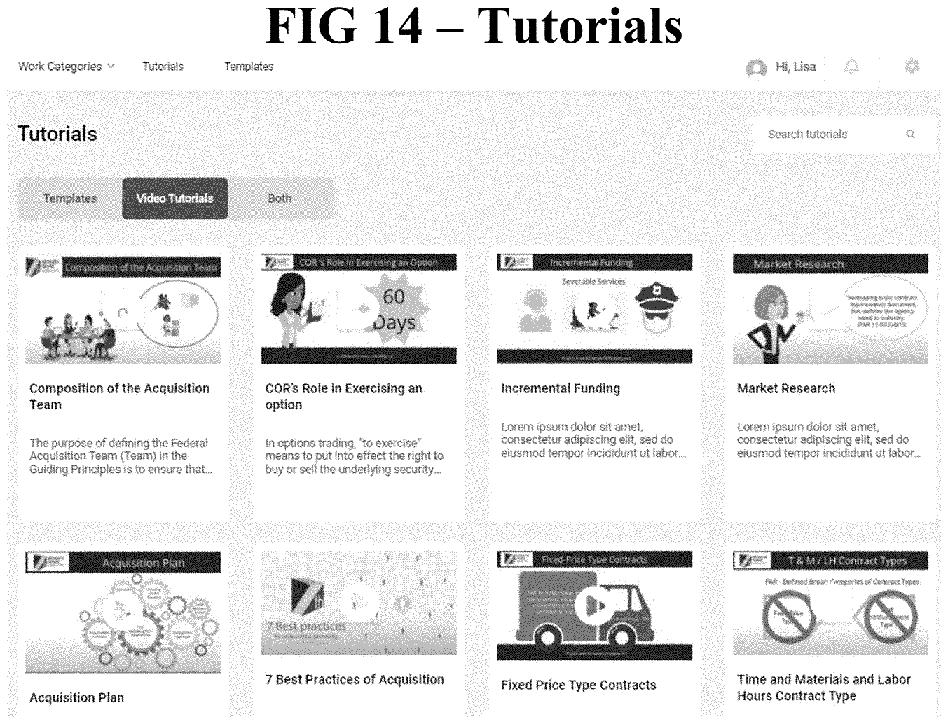

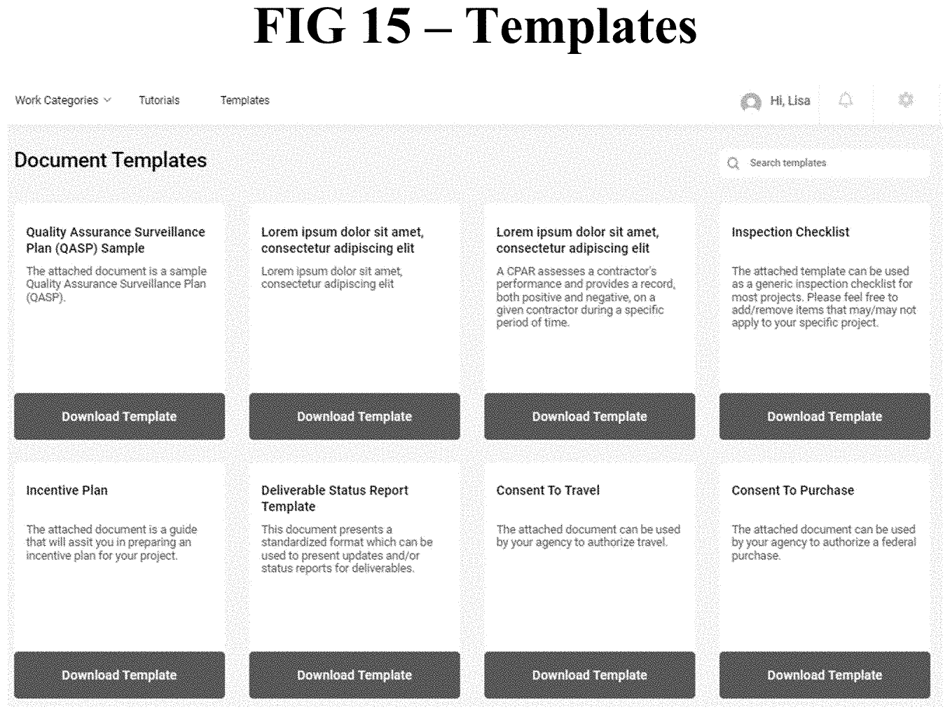

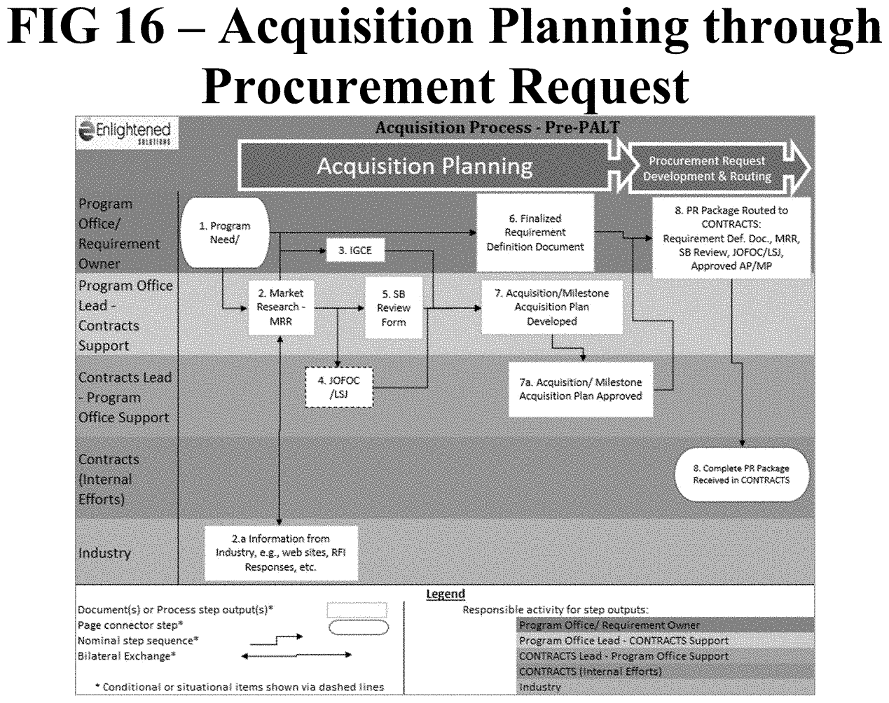

Turning to FIGS. 16-20, shown therein are the contract procurement process lifecycles in block diagram format, which are implemented in the present invention. We begin with FIG. 16.

1. Program Need/Requirement—This represents the Program Office determination that it has a need to acquire supplies or services that are not available from AGENCY in-house sources. Most often, a program need consists of at least a basic articulation of what is needed combined with some degree of confidence that some funding can be allocated.

2. Market Research—MRR—This represents the conduct of Market Research in accordance with AGENCY POLICY on Market Research, and the fact that the output of the Market Research effort is a Market Research Report (MRR) detailing procedures, findings, analysis and conclusions reached.

2a. Information from Industry, e.g., web sites, RFI Responses, etc. —depicts the fact that Market Research processes often involve information shared with and gathered from a range of diverse types of industry sources.

3. IGCE—This step is the development of an Independent Government Cost Estimate in accordance with AGENCY POLICY on Independent Government Cost Estimate, largely supported by information in the MRR. The IGCE can help to ensure that an appropriate budget allocation is available for the requirement or lead to budget-constrained tailoring in defining the requirement. Subsequently in the process, the IGCE can provide key support to determining price reasonableness of the ultimate award.

4. JOFOC/LSJ—This conditional step represents the fact that if the MRR indicates that only one source can meet the need, then a specific formal authorization is required. These terms are “Justification for Other than Full and Open Competition” (FAR Subpart 6.3) and, for FSS orders, “Limited Source Justification” (FAR 8.405-6). The CO must be promptly consulted if the MRR indicates this situation and, if the CO agrees, the Acquisition Team prepares the appropriate sections of a FAR-compliant Justification for Other than Full and Open Competition (JOFOC) or Limited Source Justification (LSJ) and the CO processes it for approval at the appropriate level.

5. SB Review Form—This step depicts the requirement to prepare and obtain Small Business Specialist review of the AGENCY's Small Business Program Review Form, for most proposed procurement approaches. See also AGENCY POLICY on Reviews and Approvals for the parameters when this review process is required.

6. Finalized Requirement Definition Document—The output of this step will often be a Statement of Objectives (SOO), Performance Work Statement (PWS) or Statement of Work (SOW) for services—or an appropriately detailed description of a supplies' requirement. It will start from the initial defined need of Step 1, be refined by MRR results, possibly re-scoped for affordability based on the IGCE, all presented in a fashion to enable industry to understand the AGENCY need and present their best solution. This will be supplemented by draft technical evaluation criteria, proposal content requirements, and award selection bases.

7. (and 7a) Acquisition/Milestone Acquisition Plan Developed—Approved—These steps represent the often involved and complex requirement to develop and document an appropriate Acquisition Plan or Milestone Acquisition Plan for any acquisition requirement, in accordance with AGENCY POLICY on Acquisition Planning. The plan developed must be informed by the MRR results, the IGCE, the results of the Small Business review and must reflect the approval or disapproval of the JOFOC/LSJ if a source limitation is proposed. All of these are germane to the acquisition approach that must be properly documented. The customer (planner, often the COR) leads the development effort with AGENCY support. The process of review and approval at the appropriate level is led by AGENCY personnel with support from planner/COR/customer personnel as necessary. For large dollar value requirements, the approval of a formal AP may also require review via an AGENCY-prescribed Acquisition Review Board (ARB).

8. PR Package Routed to CONTRACTS—This step represents the assembly of a complete PR package, which must be supported by attachment of appropriate supporting documents including the Requirement Definition Document (Step 6), MRR (Step 2), IGCE (Step 3), JOFOC/LSJ (Step 4), SB review (Step 5), and Approved AP document (Step 7). Once assembled, the PR is routed by the Program Office in the Delphi and ESC PRISM systems, via the Budget and Finance offices, to CONTRACTS. Receipt of the complete PR in CONTRACTS ends the Acquisition Planning through Procurement Request process and begins the measurement of PALT.

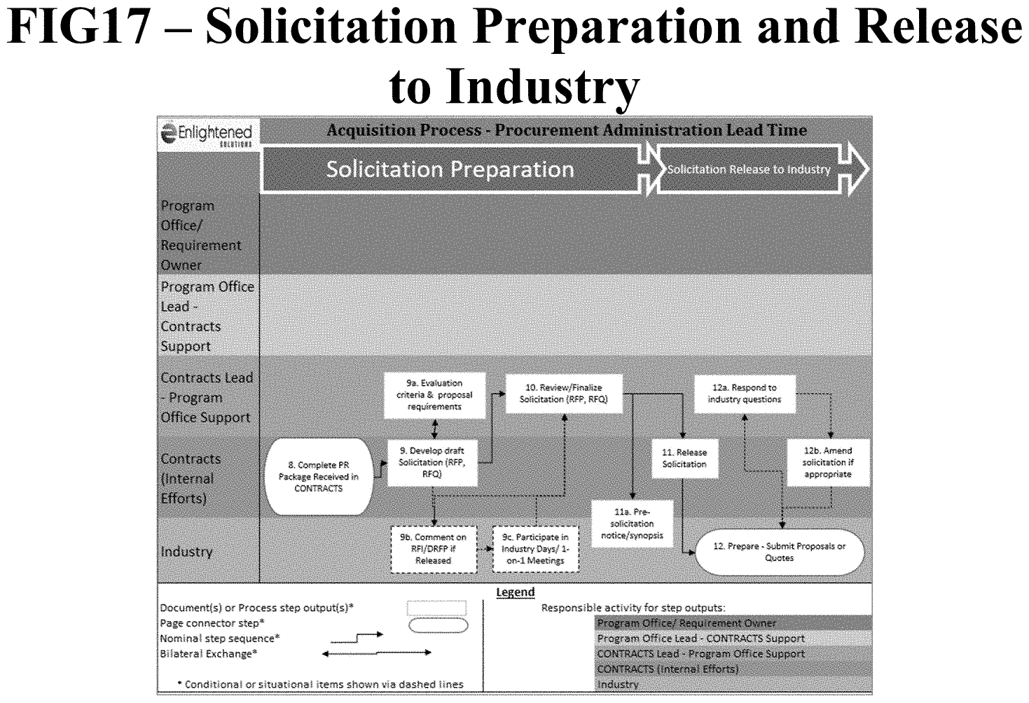

We now turn to FIG. 17.

9. Develop draft Solicitation (RFP, RFQ)—This step involves the development of the formal request to be submitted for firms to propose their respective solutions to meet the AGENCY need. This step includes interactions depicted at step 9a between CONTRACTS personnel and technical/programmatic Acquisition Team members to determine how to evaluate offers and select the awardee from among those firms that submit offers. This step may also include engagement of industry via venues such as the step 9b. publication of Requests for Information (RFIs) or Draft Requests for Proposal (DRFPs) requesting written industry feedback or per step 9c., the direct engagement via Industry Days or One-on-One meetings with firms.

10. Review/Finalize Solicitation (RFP, RFQ)—This step includes making any final changes to the solicitation document based on feedback received from steps 9a, 9b, and 9c. It also includes obtaining legal and other reviews and approval for release, as outlined in AGENCY POLICY on Reviews and Approvals.

11. Release Solicitation—This step includes either posting of the solicitation for industry offers in SAM.gov on eBuy for MAS acquisition approaches, or as appropriate for Governmentwide Acquisition Contracts (GWACs) and other multi-agency contracts.

12. Prepare—Submit Proposals or Quotes—Is the step in which industry firms prepare their responsive offers to meet the AGENCY need. Note, however, that 12a is an interactive process in which industry members can submit questions—most often regarding technical issues to increase their understanding of the AGENCY need. Also note that, as a result of issues raised by industry questions, it may become necessary to issue an amendment—step 12b—to the solicitation's terms, such as to clarify ambiguous provisions or merely to allow more time for proposal preparation.

13. Proposals or Quotes Received—This step includes the receipt of proposals or quotes and generally includes a review by CONTRACTS of each offer to ensure compliance with proposal formatting and contents constraints.

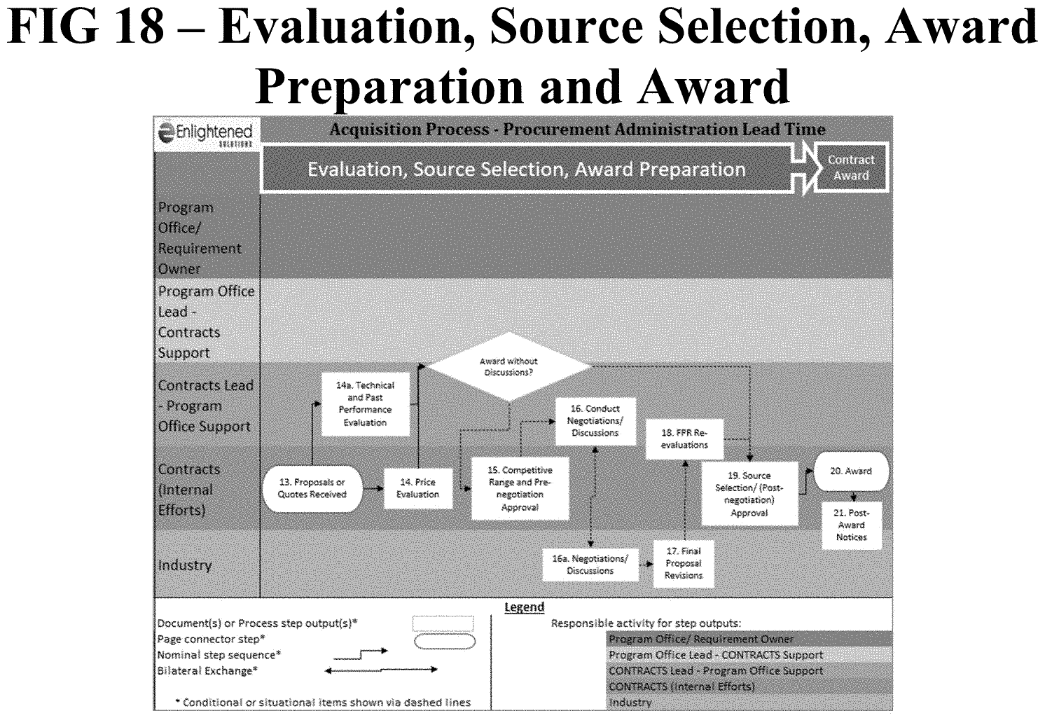

We now turn to FIG. 18.

14. (and 14a) Price Evaluation and Technical and Past Performance Evaluation—This step depicts the evaluation of offers with respect to prices offered and the solicitation's non-cost factors in support of the ultimate source selection decision.

15. Competitive Range and Pre-negotiation Approval—This step depicts the determination of a competitive range of the “most highly rated” firms and the approval of a Pre-negotiation Memorandum, if required pursuant AGENCY POLICY on Reviews and Approvals. When required, this document grants authority to enter negotiations. In some cases, where there is a fully compliant clear winning offer and the solicitation reserves the right, a decision may be made to “award without discussions.” If so, the process skips steps 15-18.

16. (and 16a) Conduct Negotiations—These depict the interaction between representatives of AGENCY and each firm in the competitive range to address deficiencies of each firm's respective offer. The AGENCY team may also opt to address relatively minor weaknesses and strengths with each firm.

17. Final Proposal Revisions—This step depicts industry responding, if they desire, to issues raised in negotiations with proposal revisions (FPRs) to improve their chances of being selected for award.

18. FPR Re-evaluations—This step depicts the re-evaluation of the firms' respective proposals as altered by the FPRs.

19. Source Selection and Post-Negotiation Approval—This step depicts the selection of the best solution to meet the AGENCY need, based on the evaluation (re-evaluation) results of each firm's submissions. This selection may be documented via a formal Source Selection Decision Document (SSDD). The SSDD serves as the most critical information supporting the Post-Negotiation Memorandum, the approval of which authorizes award of the contract pursuant to AGENCY POLICY on Reviews and Approvals.

20. Award—The CO ensures that all requirements of law, executive orders, regulations, and all other applicable procedures, including documentation, clearances and approvals have been complied with and makes the award. This ends the measurement of PALT.

21. Post-Award Notices—This step depicts the fact that there are various notices required to accompany the award of most contract actions. The exact nature of such required notices depends on factors such as dollar value.

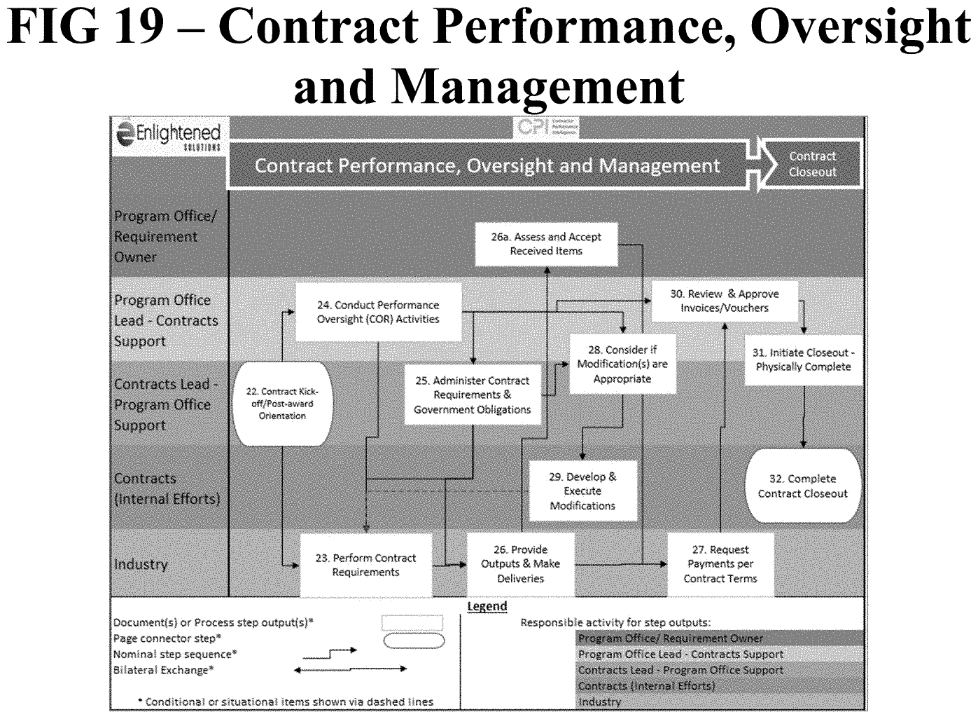

We now turn to FIG. 19. The present invention provides intelligent process automation for the procedures shown in the figure as well as sub-procedures that are not detailed in the figure.

22. Contract Kick-off/Post-award Orientation—This step could consist of a relatively informal meeting or a more formal event that orients the new Contractor to the Government's needs and requirements to foster mutual understanding of both parties and their respective key personnel. To determine meeting degree of formality, consider the magnitude and complexity of the contract, as well as the contractor's overall experience and history with the AGENCY. Minutes should be developed and issued for Post-award Orientations.

23. Perform Contract Requirements—This step depicts the Contractor's efforts to meet contract requirements, providing the required services and supplies.

24. Conduct Performance Oversight (COR) Activities—This step depicts the process of managing and overseeing the contractor's performance efforts under Step 23. It includes activities such as, but not limited to, executing the monitoring activities specified in the QASP, potentially the use of in-process inspection or test procedures for supplies, as well as other requirements that may be delineated within the Contract.

25. Administer Contract Requirements—This step includes the efforts and processes to meet the Government's obligations under a contract, such as timely provision and management of GFE/GFP/GFI, ensuring access to Government facilities and systems when warranted and as necessary for Contractor personnel, receipt, analysis, approval and timely payment of contractor invoices, plus conduct of contract closeout. This step, the Step 24 Performance Oversight Activities and the Step 26 Assessment and Acceptance of Received Items are closely intertwined and sometimes are considered as a single category of all those Government activities occurring from the point of award through contract closeout.

26. Provide Outputs and Make Deliveries—This step includes the presentation/proffering of contract deliverable requirements, such as required reports of results or delivery of supplies as being compliant with contract requirements and objectives, for acceptance by the Government.

26a. Assess and Accept Received Items—This step includes the review of all services, reports of accomplishments, and pre-acceptance inspection and test, as appropriate, of supplies upon delivery.

27. Request Payments per Contract Terms—This step includes electronic or other format requests for payment (invoices or vouchers), based on periodic entitlement or acceptance of supplies delivered/services performed.

28. Consider if Modification(s) are Appropriate—Modifications to a contract may arise for various reasons and may be proposed by the Contractor, determined appropriate by the Government to obtain to improve or ensure contract objectives are achieved, or contemplated by contract terms, such as funding increments or option exercises. If a modification is deemed appropriate, a PR package would be generated and processed to contracts per Steps 6-8, and potentially Step 4. The Modification Consideration Decision Process is included in FIG. 20.

29. Develop and Execute Modifications—This step includes pertinent steps from within Steps 9 through 20, tailored for the fact competition-specific steps are not needed, sole source negotiations with cost data support may be appropriate. Or, for modifications such as incremental funding or timely option exercises, may be issued unilaterally and without the need for solicitation or negotiation. Upon execution, Contractor performance requirements per Step 23 will usually be revised.

30. Review & Approve Invoices/Vouchers—Based on contract terms and information generated via Steps 24, 25 and 26a, billings must be approved, rejected with explanation or partially approved with explanation of any portion not approved.

31. Initiate Closeout—Physically Complete—This step follows completion by the contractor of all contractual requirements to determine physical completion.

32. Complete Closeout—This step includes the steps defined at FAR 4.804, as appropriate to the specific contract and preparation of the contract file for archiving per FAR 4.805. This is the final segment of the contract procurement process lifecycle.

We now expand on the Modification Consideration Decision Process in FIG. 20 from step 28 above.
1. First consideration is whether the contract revisions under consideration would only revise government administrative information included within the contract that does not affect the contractor's rights or duties under the contract.
2. If such government-data revisions are the only changes needed, the system queries the user to specify needed revision and provide any supporting documentation related as needed per agency policies.
3. If other considerations need to be addressed, the system queries the user on whether the modification under consideration is necessary to fulfill an existing government obligation under the contract, needed to enable the contractors to continue performance, such as additional funds or additional government-furnished property. If such government action is required per the contract, the system then queries whether additional funds are required and guides the user through the process to add funds. If the modification under consideration is not needed for a required government action, the system moves to the next decision.
4. The system next queries whether the potential revision is within the contract scope and is needed to ensure its outcomes meet the current/updated government needs and priorities. If the revision is within scope and does improve alignment with the government need, the system queries if additional funds are required guiding the user through that process as well as the definition of the desired performance revision so that a contract modification can be sent to the Contracting Officer and the contract writing system. If the modification under consideration is not within the contract's general scope, the system guides the user to the next step of the process.
5. If the revision under consideration exceeds the existing general scope, then the potential modification would constitute additional supplies and/or services. The system queries if the added supplies and/or services were anticipated in a contract option that can be exercised. If an option exists, the system queries to ensure that contractor performance is at least satisfactory. If so, the system guides the user through the final process to request the modification. If an option does not exist, the system queries if a sole source procurement from the contractor of the added supplies/services can be properly justified and approved. If the sole source justification is not approved, the system informs the user that no modification should be request. If the sole source justification is approved, the system guides the user through final process to request the modification.

What is claimed is:

1. An apparatus for managing a contract, including a U.S. government contract, comprising:
an on-premises network to be coupled to an external network, said on-premises network including a first collaborative server having a front end application server, a first email server and a first database server, said front-end server coupled to the email server and the first database server;
an off-premises network to be coupled via said external network to the on-premises network, said off-premises network including a second collaborative server having a web server, a second email server and a second database server, said web server coupled to the second email server, and the second database server; and
said front end application server including a non-transitive computer readable media having encoded thereon instructions causing the front end application server to provide a contractor performance intelligence application:
said contractor performance intelligence application including a graphical user interface through which a user, such as a contracting officer's representative, can manage a plurality of aspects of a government contract throughout a life cycle of a government contract, including post-award activities, scheduling, costs, and contractor performance.

2. The apparatus according to claim 1, wherein said contractor performance intelligence application:
a) enables a plurality of users to manage a plurality of government contracts, wherein said users include contracting officers, contracting officer's representatives, supervisory personnel of said contracting officers and said contracting officer's representatives, security officers, technical representatives, and accountants; and
b) enables supervisory personnel to review performance criteria of a plurality of government contracts being managed by a plurality of other users.

3. The apparatus according to claim 1, wherein said contractor performance intelligence application includes an early warning system identifying one or more projects at risk of delayed schedules, cost overruns, unsatisfactory quality and poor contractor performance.

4. The apparatus according to claim 1, wherein said contractor performance intelligence application includes an automation process for requesting a contract modification that guides a user through a modification consideration decision process that prompts the user with questions to shape steps necessary to develop a contract modification request in accordance with U.S. government federal acquisition regulations.

5. The apparatus according to claim 1, wherein said contractor performance intelligence application includes a plurality of video tutorials and templates that are linked to one or more of a plurality of specific activities, whereby a user can select any of said plurality of video tutorials and templates to help guide the user when performing one of said plurality of specific activities.

6. The apparatus according to claim 1, wherein said contractor performance intelligence application provides a plurality of different user roles and allows each of said different user roles to search, filter and access files through multiple ways, including by lists of projects, activities, invoices, contractors, repositories and reports.

7. The apparatus according to claim 1, wherein said contractor performance intelligence application provides an ask the experts capability to enable users to ask acquisition-related questions to which said contractor performance intelligence application provides ad-hoc responses to new questions that have not been posed by any user or answered previously, as well as pre-programmed responses to questions previously posed or answered.

8. The apparatus according to claim 1, wherein said plurality of aspects of a government contract further comprises:
a) a plurality of performance oversight and management activities by a contracting officer's representative;
b) a plurality of financial and administrative oversight functions by a contracting officer's representative; and
c) a plurality of closeout process assistance functions by a contracting officer's representative.

9. The apparatus according to claim 9, wherein:
a) said performance oversight and management activities include one or more of the following:
(i) planning and documenting post-award orientation, including a kick-off meeting;
(ii) creating and executing a contract management plan;
(iii) creating and executing a quality assurance surveillance plan;
(iv) retaining and storing all records related to deliverables and performance incentives in said first and second databases;
(v) providing technical direction and advice on technical matters;
(vi) communicating with a contracting officer regarding performance and schedule issues via the first and second email servers;
(vii) managing a schedule for deliverables and coordinate government review of deliverables;
(viii) submitting one or more requests for contract modification;
(ix) preparing input to one or more contractor performance assessment reports; and
(x) inspecting and accepting materials submitted by one or more contractors;
b) wherein said plurality of financial and administrative oversight functions include one or more of the following:
(i) accounting for government furnished property and government furnished information;
(ii) managing a financial status of said government contract;
(iii) tracking one or more invoices and payment vouchers;
(iv) storing and retaining all records related to one or more requests to travel, and one or more requests to purchase other direct costs; and
(v) coordinating one or more security background checks and one or more site entry matters for a plurality of contractor personnel; and
c) wherein said plurality of closeout process assistance functions include one or more of the following:
(i) preparing for closeout of said government contract; and
(ii) preparing for final contract modification to closeout said government contract.

10. The apparatus according to claim 1, wherein the contractor performance intelligence application employs a hierarchical data structure starting with a plurality of projects, such as contracts, each of which employs a plurality of activities, which in turn employs a plurality of action items for each activity, and a plurality of notifications related to one activity or one action item.

11. A non-transitive computer readable media having encoded thereon a plurality of instructions causing a processor to provide a contractor performance intelligence application that includes:
a graphical user interface through which a user, such as a contracting officer's representative, can manage a plurality of aspects of a government contract throughout a life cycle of a government contract, including post-award activities, scheduling, costs, and contractor performance;
said contractor performance intelligence application:
a) enabling a plurality of users to manage a plurality of government contracts, wherein said users include contracting officers, contracting officer's representatives, supervisory personnel of said contracting officers and said contracting officer's representatives, security officers, technical representatives, and accountants;
b) enabling one or more supervisory personnel to review performance criteria of a plurality of government contracts being managed by a plurality of other users;
c) including an early warning system identifying one or more projects at risk of delayed schedules, cost overruns, unsatisfactory quality and poor contractor performance;
d) including an automation process for requesting a contract modification that guides a user through a modification consideration decision process that prompts the user with questions to shape steps necessary to develop the contract modification request in accordance with U.S. government federal acquisition regulations;
e) including a plurality of video tutorials and templates that are linked to one or more specific activities whereby a user can select any of said plurality of video tutorials and templates to help guide the user when performing one of said one or more specific activities;
f) providing a plurality of different user roles and allows each of said different user roles to search, filter and access files through multiple ways, including by lists of projects, activities, invoices, contractors, repositories and reports; and
g) providing an ask the experts capability an ask the experts capability to enable users to ask acquisition-related questions to which said contractor performance intelligence application provides ad-hoc responses to new questions that have not been posed by any user or answered previously, as well as pre-programmed responses to questions previously posed or answered.

12. The non-transitive computer readable media according to claim 11, wherein said plurality of aspects of a government contract further comprises:
a) a plurality of performance oversight and management activities by a contracting officer's representative;
b) a plurality of financial and administrative oversight functions by a contracting officer's representative; and
c) a plurality of closeout process assistance functions by a contracting officer's representative.

13. The non-transitive computer readable media according to claim 12, wherein said performance oversight and management activities include one or more of the following:
a) planning and documenting post-award orientation, including a kick-off meeting;
b) creating and executing a contract management plan;
c) creating and executing a quality assurance surveillance plan;
d) retaining and storing all records related to deliverables and performance incentives in said first and second databases;
e) providing technical direction and advice on technical matters;
f) communicating with a contracting officer regarding performance and schedule issues via the first and second email servers;
g) managing a schedule for deliverables and coordinate government review of deliverables;
h) submitting one or more requests for contract modification;
i) preparing input to one or more contractor performance assessment reports; and
j) inspecting and accepting materials submitted by one or more contractors.

14. The non-transitive computer readable media according to claim 12, wherein said plurality of financial and administrative oversight functions include one or more of the following:
a) accounting for government furnished property and government furnished information;
b) managing a financial status of said government contract;
c) tracking one or more invoices and payment vouchers;
d) storing and retaining all records related to one or more requests to travel, and one or more requests to purchase other direct costs; and
e) coordinating one or more security background checks and one or more site entry matters for a plurality of contractor personnel.

15. The non-transitive computer readable media according to claim 12, wherein said plurality of closeout process assistance functions include one or more of the following:
a) preparing for closeout of said government contract; and
b) preparing for final contract modification to closeout said government contract.

16. The non-transitive computer readable media according to claim 13, wherein the contractor performance intelligence application employs a hierarchical data structure starting with a plurality of projects, such as contracts, each of which employs a plurality of activities, which in turn employs a plurality of action items for each activity, and a plurality of notifications related to one activity or one action item.

17. A method for managing a government contract using an intelligent process embedded in a contractor intelligence performance application for execution on a server comprising the steps of:
providing a graphical user interface through which a user, such as a contracting officer's representative, can manage a plurality of aspects of a government contract throughout a life cycle of a government contract, including post-award activities, scheduling, costs, and contract performance;
providing access to the contractor performance intelligence application by predetermined user roles for a plurality of users to manage a plurality of government contracts, wherein said users include one or more of the following: contracting officers, contracting officer's representatives, supervisory personnel of said contracting officers and said contracting officer's representatives, security officers, technical representatives, and accountants;
providing access to the contractor performance intelligence application to one or more supervisory personnel to enable said one or more supervisory personnel to review performance criteria of a plurality of government contracts being managed by a plurality of other users;
identifying automatically by an early warning system one or more projects at risk of delayed schedules, cost overruns, unsatisfactory quality and poor contractor performance;
automating a process for requesting a contract modification that guides a user through a modification consideration decision process that prompts the user with questions to shape steps necessary to complete the contract modification;
providing one or more video tutorials and templates that are linked to one or more specific activities, whereby a user can select any of the one or more video tutorials and templates to help guide the user when performing one of said one or more specific activities;
providing a plurality of different user roles and allowing each of said different user roles to search, filter and access files through multiple ways, including by lists of projects, activities, invoices, contractors, repositories and reports; and
providing an ask the experts capability to enable users to ask acquisition-related questions to which said contractor performance intelligence application provides ad-hoc responses to new questions that have not been posed by any user or answered previously, as well as pre-programmed responses to questions previously posed or answered.

18. The method according to claim 17, wherein said plurality of aspects of a government contract further comprises:
a) a plurality of performance oversight and management activities by a contracting officer's representative;
b) a plurality of financial and administrative oversight functions by a contracting officer's representative; and
c) a plurality of closeout process assistance functions by a contracting officer's representative.

19. The non-transitive computer readable media according to claim 18, wherein
a) said performance oversight and management activities include one or more of the following:
(i) planning and documenting post-award orientation, including a kick-off meeting;
(ii) creating and executing a contract management plan;
(iii) creating and executing a quality assurance surveillance plan;
(iv) retaining and storing all records related to deliverables and performance incentives in said first and second databases;
(v) providing technical direction and advice on technical matters;
(vi) communicating with a contracting officer regarding performance and schedule issues via the first and second email servers;
(vii) managing a schedule for deliverables and coordinate government review of deliverables;
(viii) submitting one or more requests for contract modification;
(ix) preparing input to one or more contractor performance assessment reports; and
(x) inspecting and accepting materials submitted by one or more contractors;
b) said plurality of financial and administrative oversight functions include one or more of the following:
(i) accounting for government furnished property and government furnished information;
(ii) managing a financial status of said government contract;
(iii) tracking one or more invoices and payment vouchers;
(iv) storing and retaining all records related to one or more requests to travel, and one or more requests to purchase other direct costs; and
(v) coordinating one or more security background checks and one or more site entry matters for a plurality of contractor personnel; and
c) said plurality of closeout process assistance functions include one or more of the following:
(i) preparing for closeout of said government contract; and
(ii) preparing for final contract modification to closeout said government contract.

20. The method according to claim 17, further comprising employing a hierarchical data structure starting with a plurality of projects, such as contracts, each of which employs a plurality of activities, which in turn employs a plurality of action items for each activity, and a plurality of notifications related to one activity or one action item.
